(19) United States
(12) Patent Application Publication
(10) Pub. No.: US 2025/0216559 A1
(43) Pub. Date: Jul. 3, 2025

(54) CLOUD-BASED DETECTION OF GNSS SPOOFING, INCLUDING RESIDUAL AND USE OF NON-GNSS COMPONENTS

(71) Applicant: Spirent Communications plc, Crawley (GB)

(72) Inventors: Jeremy Charles Bennington, Greenwood, IN (US); Paul Hansen, Cambridge (GB); Dan Tillett, Trusham (GB)

(73) Assignee: Spirent Communications plc, Crawley (GB)

(21) Appl. No.: 19/087,300

(22) Filed: Mar. 21, 2025

Related U.S. Application Data
(63) Continuation-in-part of application No. 17/948,176, filed on Sep. 19, 2022.
(60) Provisional application No. 63/568,400, filed on Mar. 21, 2024.
(60) Provisional application No. 63/407,589, filed on Sep. 16, 2022.

(51) Int. Cl. G01S 19/21

(52) U.S. Cl. CPC G01S 19/215

(57) ABSTRACT

The technology disclosed teaches distributed networks and methods for cloud processing for global navigation satellite system (GNSS) interference data from a plurality of GNSS receivers to alert aircraft personnel to GNSS spoofing of aircraft guidance systems. The technology disclosed includes receiving at a cloud-based server, GNSS interference data from the plurality of GNSS receivers, analyzing the GNSS interference data upon receipt, identifying an interference event from the analyzed GNSS interference data, and in response to an identified interference event, the cloud-based server providing an alert to EFB tablet devices onboard the aircraft thereby causing notification of aircraft personnel of a potential spoofing event.

### PRIORITY

This application claims the benefit of U.S. Provisional Application No. 63/568,400 titled “Cloud-Based GNSS Spoofing Alert and Detection,” filed 21 Mar. 2024 (Attorney Docket No. SPIR 1175-1). It claims priority as a continuation-in-part of U.S. application Ser. No. 17/948,176 titled “GNSS Forecast and Spoofing/Jamming Detection,” filed 19 Sep. 2022 (Attorney Docket No. SPIR 1169-3), which claims the benefit of U.S. Provisional Application 63/407,589 titled “Accuracy of a GNSS Receiver that has a Non-Directional Antenna,” filed 16 Sep. 2022 (Attorney Docket No. SPIR 1169-1). The priority applications are incorporated by reference for all purposes.

### RELATED CASES

A trio of related applications in the US were contemporaneously filed on 21 Mar. 2025 with substantially identical specifications and inventors, all claiming the benefit of U.S. Provisional Application No. 63/568,400 titled “Cloud-Based GNSS Spoofing Alert and Detection,” filed 21 Mar. 2024. The contemporaneously filed applications are:

U.S. application Ser. No. ______ titled “Cloud-Based GNSS Spoofing Detection and Alert,” (Attorney Docket No. SPIR 1175-3), and

U.S. application Ser. No. ______ titled “Cloud-Based Detection of GNSS Interference and Alert to Potential Spoofing.” (Attorney Docket No. SPIR 1175-5).

A related UK Application No. 2504094.0 titled “Cloud-Based GNSS Spoofing Detection and Alert” (Attorney Docket No. SPIR 1175-6) spanning the trio of US applications was filed on 20 Mar. 2025, claiming priority to the contemporaneously filed applications.

This application also is related to the following commonly owned applications:

United Kingdom Patent Application No. 2406732.4, titled “Cloud-based GNSS Spoofing Alert and Detection,” filed 13 May 2024 (Attorney Docket No. SPIR 1175-2) which claims priority to U.S. Provisional Application No. 63/568,400 titled “Cloud-Based GNSS Spoofing Alert and Detection,” filed 21 Mar. 2024 (Attorney Docket No. SPIR 1175-1).

U.S. application Ser. No. 17/948,171 titled “GNSS Forecast Impacting Receiver Startup,” filed 19 Sep. 2022 (Attorney Docket No. SPIR 1169-2); and

U.S. application Ser. No. 17,948/182 titled “GNSS Forecast and Background Obscuration Prediction,” filed 19 Sep. 2022 (Attorney Docket No. SPIR 1169-4); and

U.S. application Ser. No. 17/948,171 titled “GNSS Forecast and Line of Sight Detection” filed 19 Sep. 2022 (Attorney Docket No. SPIR 1169-5); and

U.S. application Ser. No. 17,948/182 titled “Utilizing GNSS Risk Analysis Data for Facilitating Safe Routing of Autonomous Drones” filed 19 Sep. 2022 (Attorney Docket No. SPIR 1164-2); and

U.S. application Ser. No. 17/948,218 titled “Generating and Distributing GNSS Risk Analysis Data for Facilitating Safe Routing of Autonomous Drones” filed 19 Sep. 2022 (Attorney Docket No. SPIR 1164-3).

The related applications are incorporated by reference for all purposes.

### INCORPORATIONS

The following materials are incorporated by reference for all purposes as if fully set forth herein:

U.S. application Ser. No. 17/374,882 entitled “Accuracy of A GNSS Receiver That Has a Non-Directional Antenna,” (Attorney Docket No. SPIR 1139-5) filed 13 Jul. 2021 and

U.S. application Ser. No. 17/374,891, titled “Path Planning Using Forecasts of Obscuration and Multipath” filed 13 Jul. 2021 (Attorney Docket No, SPIR 1139-6); and

Recommendation ITU-R P.681-11 (8/2019), Propagation data required for the design systems in the land mobile-satellite service; and

Recommendation ITU-R P.681-11 (8/2019), Propagation data required for the design systems in the land mobile-satellite service; and

Report ITU-R P.2145-2, (9/2017), Model parameters for the physical-statistical wideband model in Recommendation ITU-R P.681; and

Recommendation ITU-R P.1407-7, (8/2019), Multipath propagation and parameterization of its characteristics; and

GB Application No. 1111305.7, titled Recording, Storage and Playback of GNSS Signals,, filed 4 Jul. 2011, now GB Patent No. 2492547, issued 7 Nov. 2018 (Attorney Docket No. SPIR 1134-1GB); and

U.S. application Ser. No. 13/786,20, titled System and Method for Testing Real World A-GNSS Performance of A Device, filed 5 Mar. 2013, now U.S. Pat. No. 9,519,063, issued 13 Dec. 2016 (Attorney Docket No. SPIR 1071-1); and

Federal Aviation Administration (FAA) Technical Standard Order (TSO)-C199 for Traffic Awareness Beacon System (TABS)

### FIELD OF THE TECHNOLOGY DISCLOSED

The technology disclosed relates to data processing, aircraft, navigation and relative location. The technology disclosed provides for electrical computers, digital data processing systems, and data processing processes for transferring data between a plurality of computers or processes wherein the computers or processes employ the data before or after transferring and the employing affects the transfer of data therebetween.

In particular, the technology disclosed relates to using a cloud-based alert system for processing GNSS reported positions to detect a GNSS spoofing event and alerting aircraft crew of the detected GNSS spoofing event.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

Aircraft require accurate global navigation satellite system (GNSS) data (e.g., GPS, GLONASS, Galileo, etc.) to function efficiently and safely. However, the aviation industry is experiencing an increased number of GNSS spoofing or jamming events (referred to collectively as GNSS interference events), leading to an increase in safety risk and rates of cancelled/delayed flights. In one example, GNSS spoofing events have occurred in regions over Russia, Bulgaria, Poland, Romania, Turkey, Israel, and Pakistan. In another example, certain delays and cancellations at U.S. commercial airports in recent years have been attributed to GNSS interference events.

Certified avionics systems relying on GPS L1 are vulnerable to many types of failures as a consequence of a GNSS interference event. In response to GNSS spoofing or jamming attacks, certified avionics systems may experience a navigation fail or reversion event. Position information reported via Automatic Dependent Surveillance-Broadcast (ADS-B) may incorrectly locate the plane's position, impacting other aircraft crews and air traffic control (ATC). The impact of incorrect ADS-B reporting may extend to channels, weather, air traffic, etc. Incorrect position and altitude data may impact Ground Proximity Warning Systems (GPWS) and Terrain Awareness and Warning Systems (TAWS). Other areas of risk include inconsistencies with and potential resetting of an inertial navigation system (INS). Also autopilot failures, attitude and heading reference system (AHRS) failures, and heading indicator failures. Collectively, such problems related to positioning, navigation and timing (PNT) technology have a significant impact on commercial/civil aviation as well as the defense sector.

An opportunity arises for providing a cloud-based alert system for processing GNSS data to detect spoofing events and alert aircraft crews in-flight, as well as ATC and other GNSS users, of detected spoofing events. The disclosed technology can aid in preventing atypical PNT errors and corruption of PNT sources, detecting atypical errors or anomalies of PNT sources, responding quickly and appropriately to detected atypical errors or anomalies (including by reporting, mitigation, and/or containment mechanisms), and recovering from atypical errors in order to return to a proper working state and defined performance. The disclosed technology can improve both real time and route planning for both terrestrial and airborne vehicles, by providing improved information about the potential GNSS interference events affecting the reliability of GNSS signal data.

### SUMMARY

The technology disclosed involves a distributed network and methods for cloud processing of ADS-B data, GNSS signal data, and other forms of GNSS interference data to alert aircraft personnel to GNSS spoofing of aircraft guidance systems. The technology disclosed can be implemented using a cloud-based server of a cloud-based alert system receiving data from one or more sources. Useful data includes ADS-B integrity, track and position data, GNSS integrity data, GNSS signal data, GNSS interference data, and other forms of PNT data. These data are evaluated to detect a potential GNSS spoofing event and alert onboard aircraft personnel of the GNSS spoofing (or a potential of GNSS spoofing) via an Electronic Flight Bag (EFB) tablet device or other software running on hardware onboard the aircraft or other supplemental systems that do not rely on the same GNSS as the ADS-B system. A wide range of implementations apply the technology disclosed.

Particular aspects of the technology disclosed are described in the claims, specification and drawings.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

The patent or application file contains at least one drawing executed in color. Copies of this patent or patent application publication with color drawing(s) will be provided by the Office upon request and payment of the necessary fee. The color drawings also may be available in PAIR via the Supplemental Content tab.

FIG. 1 shows an example architecture for cloud processing of GNSS data to alert aircraft personnel to GNSS spoofing of aircraft guidance systems, according to one implementation of the disclosed technology.

FIG. 2 shows an example schematic of GNSS spoofing of aircraft guidance systems.

FIG. 3 shows a block diagram for various cloud-based approaches of processing GNSS data to alert personnel to GNSS spoofing of aircraft guidance systems, according to one implementation of the disclosed technology.

FIG. 4A shows a block diagram for GNSS spoofing detection using an external GNSS receiver, according to one implementation of the technology disclosed.

FIG. 4B shows a block diagram for GNSS spoofing detection using an external GNSS receiver and a cloud-based alert system for GNSS spoofing detection and notification.

FIG. 4C shows a block diagram for GNSS spoofing detection using an external GNSS receiver, ADS-B receivers, a cloud-based alert system for GNSS spoofing detection and notification.

FIG. 4D shows a block diagram for GNSS spoofing detection using GNSS data obtained from certified avionics and a cloud-based alert system for GNSS spoofing detection and notification.

FIG. 4E shows a block diagram for GNSS spoofing detection using GNSS data obtained from a plurality of GNSS receiver sources and a cloud-based alert system for GNSS spoofing detection and notification.

FIG. 5 shows a block diagram for a distributed network configured to analyze global navigation satellite system (GNSS) interference data from a plurality of GNSS receiver sources to detect spoofing events impacting a plurality of aircraft.

FIG. 6 is a graph of using a scaled barometric altitude ratio.

FIGS. 7A, 7B and 7C illustrate one approach that uses spoofing_start and spoofing_end locations reported by flights through the region.

FIGS. 8A, 8B, 8C, 8D and 8E illustrate another approach that relies on spoof start but not stop locations.

FIGS. 9A and 9B illustrate a ratio of barometric altitude in feet divided by groundspeed in knot and scaling of the ratio on a scale of 1 to 5, with special rules for low speed flight and high speed flight at low altitudes.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Aircraft navigation often depends on positioning information from satellite constellations, such as GPS, GLONASS, Galileo, and GNSS more generally. In recent years, the aviation industry has experienced a concerning rise in the occurrence of GNSS interference events, including spoofing and jamming incidents. These events pose significant safety risks and lead to heightened rates of flight cancellations and delays.

Increasingly, GNSS interference events are being reported in various regions globally, causing disruptions and safety hazards. Both position and altitude reporting are impacted. The impact extends beyond mere inconvenience, as these events can result in navigation failures, ADS-B malfunctions affecting aircraft crews and air traffic control, and failures of critical systems like Ground Proximity Warning Systems (GPWS) and Terrain Awareness and Warning Systems (TAWS). Such failures compromise the integrity of aircraft navigation technology, affecting both commercial and defense sectors.

To address this critical issue, there is a pressing need for a solution that can effectively detect and mitigate GNSS interference events in real-time. The disclosed cloud-based alert system presents a promising opportunity to process GNSS data and detect spoofing events promptly, rather than retrospectively using historical data. By leveraging cloud technology, this solution can provide timely alerts to aircraft crews, air traffic control, and other GNSS users, enabling them to take necessary precautions and mitigate risks associated with spoofing.

The technology disclosed includes systems and methods to prevent atypical GNSS errors and corruption of GNSS sources, detect anomalies or errors in GNSS data, respond swiftly to detected anomalies, and recover from errors to restore proper functionality. By offering improved real-time information and route planning capabilities, this solution enhances the reliability of GNSS data for terrestrial and airborne vehicles.

The technology disclosed integrates with existing Electronic Flight Bag (EFB) systems, such as tablet devices like the Apple iPad™ running applications such as Foreflight, commonly used by pilots for navigation and situational awareness. It also can be incorporated into other systems of software running on hardware that supplement the primary, ADS-B connected GNSS system. The technology disclosed also could be implemented as a module of the primary system that reports ADS-B data, even though it independently processes flight-related data. Leveraging the EFB or other supplementary platform, the solution can provide alerts directly to aircraft crews without requiring complex certification or integration processes. This immediate notification empowers crews to differentiate between GNSS interference events and equipment failures, enabling them to take appropriate actions to ensure safety.

Furthermore, the solution utilizes GNSS receivers, which are not part of certified avionics, to detect spoofing events independently. The receivers can be built into a tablet or linked to a tablet. The tablet transmits data from these receivers to cloud-based servers for analysis, allowing for the identification of anomalous signal characteristics indicative of spoofing. The certified avionics also transmit data to ADS-B networks that can be utilized. By combining data from GNSS receivers used by multiple sources, including GNSS receivers associated with ADS-B networks and cellular networks, the system enhances its detection capabilities and provides comprehensive coverage.

In addition to detecting spoofing events, a cloud-based spoofing alert system offers an approach for analyzing GNSS interference data and tracking identified events over time. This capability enables collaborative analysis across multiple GNSS receivers, enhancing the understanding of spoofing threats and their impact.

The technology disclosed provides a solution towards addressing the growing threat of GNSS interference in aviation. By leveraging cloud-based processing and integrating with EFB or other systems, the solution enhances situational awareness and enables timely response to spoofing events, ultimately contributing to the safety and efficiency of air travel.

### Acronyms

Acronyms used in this disclosure are identified the first time that they are used. These acronyms are terms of art, often used in standards documents. Except where the terms are used in a clear and distinctly different sense than they are used in the art, we adopt the meanings found in testing standards. For the reader's convenience, many of them are listed here:

| | |
|---|---|
| ADS-B | Automatic Dependent Surveillance Broadcast |
| AGC | Automatic Gain Control |
| AHARS | Attitude Heading and Reference System |
| API | Application Programming Interface |
| ATC | Air Traffic Control |
| CFIT | Controlled Flight Into Terrain |
| CMS | Content Management System |
| CDN | Content Delivery Network |
| CDNG | CDN Gateway |
| DOP | Dilution of Precision |
| EFB | Electronic Flight Bag |
| GBAS | Ground Based Augmentation System |
| GNSS | Global Navigation Satellite System |
| GPS | Global Positioning System |
| GPWS | Ground Proximity Warning System |
| IMC | Instrument Meteorological Conditions |
| NM | Nautical Mile |
| LEO | Low Earth Orbit |
| P2CDNS | Public to CDN Service |
| PNT | Position, Navigation and Time |
| RINEX | Receiver Independent Exchange Format |
| RTK | Real-Time Kinematics |
| SBAS | Space Based Augmentation System |
| TAWS | Terrain Avoidance and Warning System |
| VMC | Visual Meteorological Conditions |
| VOR/DME | Very high frequency Omni-directional Range/ |
| | Distance Measuring Equipment |
| V2X | Vehicle to Everything |

Some implementations of the disclosed method involve cloud processing of ADS-B data received from one or more sources to detect potential GNSS spoofing events affecting aircraft guidance systems. The cloud processing further includes receiving GNSS track and position data for an aircraft and comparing the ADS-B data to the operational limitations of the aircraft. In response to an anomalous flight path characteristic identified within the analyzed GNSS track and position data, a cloud-based server provides an alert to an EFB tablet device or other system onboard the aircraft, causing notification of aircraft personnel of a potential spoofing event. Anomalous flight path characteristics can include, for example, sudden position jumps, excessive speed or turn rates, or significant changes in altitude trigger alerts to aircraft personnel via the onboard EFB tablet or via an other system of software running on hardware.

Alerts of potential spoofing can also be shared with other aircraft or GNSS users. Data from detected spoofing events is stored in a cloud database for further analysis, including for use in training deep learning models to classify affected data and detect interference events. Additionally, data from multiple aircraft can be analyzed to identify areas impacted by spoofing and determine spoofing frequencies.

Many implementations of the distributed network include a cloud-based alert system and EFB tablets or other software running on hardware on each aircraft. In some implementations, an auxiliary GNSS receiver is carried onboard the aircraft that operates independently from the certified avionics system of the aircraft, referred to herein as an external GNSS receiver. Spoofing events trigger alerts based on anomalous flight path characteristics or anomalies within signal data (e.g., GNSS data received from external GNSS receivers). The cloud-based alert system can compare data from different sources, store it, and utilize deep learning models for analysis. It can also correlate GNSS data with ADS-B reports from numerous aircraft to identify spoofing sources and track patterns over time. For example, it can correlate ADS-B receiver activity data, taking into account when a particular ground station ADS-B receiver is active. The cloud based system can process ADS-B messages from particular ground station ADS-B receivers and the GNSS data associated with a detected spoofing event to aid in identifying spoofing attacks on GNSS. The ADS-B messages processed can include position, velocity, operational status and uncertainty messages. Among the data quality indicators in ADB-S messages, the system can use uncertainty indicators, accuracy indicators and integrity indicators.

Some implementations involve cloud processing of GNSS signal data from external GNSS receivers onboard aircraft to detect and alert aircraft personnel of potential spoofing events. The system can process GNSS data using both onboard and cloud-based resources. The processing further involves analyzing signal data for anomalous characteristics such as anomalous values within recorded signal strengths, elevation or azimuth of source satellites, pseudo ranges, clock stability, time codes, or missing/null values within the GNSS signal data. Alerts are sent to aircraft personnel via EFB tablets or another system of software running on hardware upon detecting anomalies indicative of spoofing events.

The method may also include analyzing GNSS integrity, track and position data to identify anomalous flight path characteristics, comparing data from certified avionics with external GNSS data, and sharing alerts with other aircraft or GNSS users. Position data can include both position and velocity. Track data refers to position over time. GNSS integrity data can include GNSS measurements of signals and heuristics evaluating the completeness, accuracy, precision, and plausibility of positions derived from GNSS signal data.

When the integrity is low and the track is normal, that can indicate jamming or residual issues after leaving a spoofed area. When the track is abnormal, the integrity does not matter from a detection perspective, but does provide guidance on how to warn pilots and provide analytics. If the integrity is high and the aircraft is spoofed, then the aircraft integrity systems will not provide indications of integrity failure, which increases the risk of a crew not detecting that something is wrong. Hence, a warning generated by the technology disclosed is more critical when systems report high integrity, despite being spoofed. This combination of factors also prioritizes susceptible aircraft for new avionics.

Monitoring the accuracy, reliability, availability and plausibility, of GNSS position and track allows the system to identify anomalous data. Similarly, a GNSS signal characteristics having measured values outside of a pre-defined acceptable range or a null value or an error message can be flagged as anomalous. An implausible, sudden change in in position or velocity that is not within the realm of physical possibility or indicative of a catastrophic failure also can be flagged. For example, civil aircraft landing systems leverage fixed ground reference stations for integrity monitoring to continuously measure GNSS signal characteristics, identify anomalous values, correct the anomalous values when possible, and in the event of an uncorrectable error, excluding the affected satellite from the aircraft's position calculation. Aircraft navigation systems leverage GNSS signal data, sent by satellites and received by GNSS receivers, to calculate the range of the aircraft from the satellites, and then to calculate three-dimensional position and time data. GNSS tracking systems record the GNSS position and time data of an aircraft at regular intervals in order to create a log of movements, thereby generating GNSS track data describing the navigation path of the aircraft. GNSS spoofing events can interfere with integrity monitoring processes.

The GNSS integrity, track and position data from multiple sources can be analyzed upon receipt, as well as stored within a cloud storage database for further analysis at a later time (e.g., using deep learning classification) to determine impacted areas and spoofing frequencies are further components of the method. Alerts are triggered by anomalous signal or flight path characteristics detected from GNSS interference data received from various sources. The system can process different types of GNSS data, store it, and utilize deep learning models for analysis. It can also track interference events over time and correlate GNSS data with ADS-B receiver activity. GNSS interference data can be processed using both onboard and cloud-based resources.

A system architecture for analyzing global navigation satellite system (GNSS) interference data from a plurality of GNSS receiver sources to detect spoofing events impacting a plurality of aircraft is described next.

### System Architecture

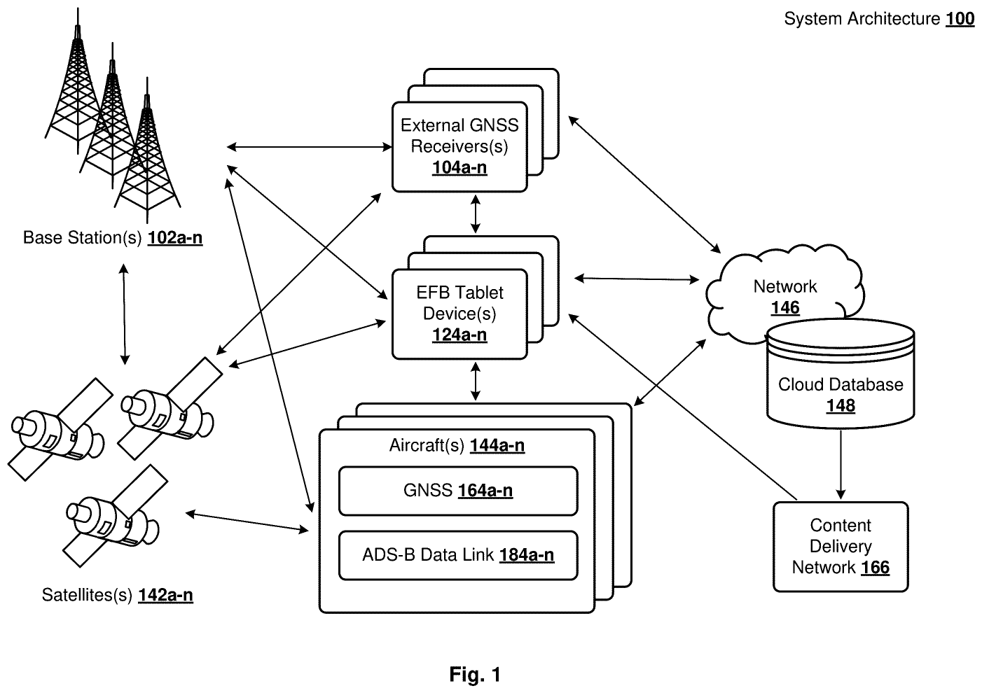

FIG. 1 shows an example architecture 100 for cloud processing of GNSS data to alert aircraft personnel to GNSS spoofing of aircraft guidance systems, according to one implementation of the disclosed technology. Because FIG. 1 is an architectural diagram, certain details are intentionally omitted to improve clarity of the description. The discussion of FIG. 1 is organized as follows. First, the elements of the figure will be described, followed by their interconnections. Then, the use of the elements in the system will be described in greater detail.

System architecture 100 includes applicant's cloud 146 with cloud database 148, content delivery network 166, aircraft 144a through 144n, satellite(s) 142a through 142n, base station(s) 102a through 102n, EFB tablet device(s) 124a through 124n, and external GNSS receiver(s) 104a through 104n. Not shown are software running on hardware alternatives to EFB systems. Each aircraft 144n contains an integrated GNSS navigation system 164a-n, comprising certified avionics, and an ADS-B data link 184a-n (also referred to herein as an ADS-B transponder). In addition, onboard each aircraft 144n is an EFB tablet device 124n, and in some aircraft, an external GNSS receiver 104n coupled to the tablet. The EFB tablet can have a built-in GNSS receiver. The EFB tablet device 124n and external GNSS receiver 104n operate independently of the certified avionics GNSS 164n. Other software running on hardware can implement the technology disclosed, as an alternative to an EFB. Each ADS-B data link 184n communicates with a network of ADS-B base stations 102a-n (also referred to herein as an ADS-B receiver) via respective ADS-B in and out channels. GNSS signals are transmitted by satellites 142a-n within satellite constellations, such as those within LEO or MEO orbits.

Each EFB tablet device 124n can be linked to GNSS receivers, such as the certified avionics GNSS receiver 164n or an external GNSS receiver 104n, and may also contain its own internal GNSS receiver. GNSS data from any of these sources can be transmitted by the EFB tablet 124n or by another system of software running on hardware to the cloud-based alert system operating via cloud network 146. The GNSS data may be processed locally on the EFB tablet 124n or another system (e.g., when connectivity to the cloud is not possible), by the cloud-based alert system operating via cloud network 146, or a combination of both. The GNSS data and other associated data, such as analytics outputs, timing and weather condition data, and/or aircraft operational limitations, can be stored on the cloud database 148 for additional processing in the future. Additional processing may be performed by a deep learning network, trained using a training database containing ground truth data for GNSS interference events and corresponding associated data, configured to detect and classify GNSS interference events.

GNSS Forecast technology can be used to determine cellular base station locations and configurations. One part of wireless communication networks is the time and synchronization of the network and devices to ensure proper transmission and handoff between base stations. One of the most common methods of achieving synchronization and timing is the use of a GPS/GNSS receiver at the cellular base station. Hence choosing the best location for a cellular base station and configuration includes ensuring good GPS/GNSS coverage and antenna placement. The disclosed GNSS Forecast can be used to help choose the cellular base station location and antenna placement. Data from receiver(s) at the base station is, after activation of the base station, available to detect spoofing and jamming.

Cellular communication networks can detect GNSS interference using at least two methods. 1) The gNodeB (wireless base station) can be synchronized using GNSS. The synchronization systems in the gNodeB include a GNSS receiver and high quality holdover oscillator. These systems can detect GNSS interference be detecting a shift in the clock/time being received from the GNSS satellites and the holdover clock. They can also detect GNSS interference by detecting a shift in position. Since gNodeB is stationary, the position should not fluctuate beyond the nominal GNSS system performance, typically a few meters. A large shift in GNSS position for a stationary base station is a clear indication of GNSS spoofing. 2) Smartphones determine their position using GNSS and support from the 4G/5G/6G network. The network can provide GNSS data received at the gNodeB that the smartphone is connected to in order to validate and speed up the smartphone's position estimation as well as detect interference, when the smartphone and gNodeB are receiving significantly different information from the GNSS signals. Moreover, the smartphone can use the 4G/5G/6G signals from multiple gNodeB base stations to determine its position by triangulation, without using GNSS. The resulting position estimation can be compared to GNSS to determine gross error and possible interference. The results of these detection methods can be combined with detection from ADS-B and other methods to improve the resolution and integrity of GNSS interference detection.

When a potential spoofing event is detected by the cloud-based alert system, the spoofing alert is communicated to the EFB device(s) 124a-n for aircraft(s) 144a-n using content delivery network 166. For further information regarding the content delivery network, reference can be made to commonly owned U.S. patent application Ser. No. 17/948,176, which is fully incorporated by reference for all purposes as if fully set forth herein.

The disclosed cloud architecture provides a distributed network configured to analyze global navigation satellite system (GNSS) interference data from a plurality of GNSS receiver sources to detect spoofing events impacting a plurality of aircraft. GNSS spoofing events affecting aircraft will now be briefly introduced before the discussion turns to various implementations of the disclosed spoofing detection and alert methods in further detail.

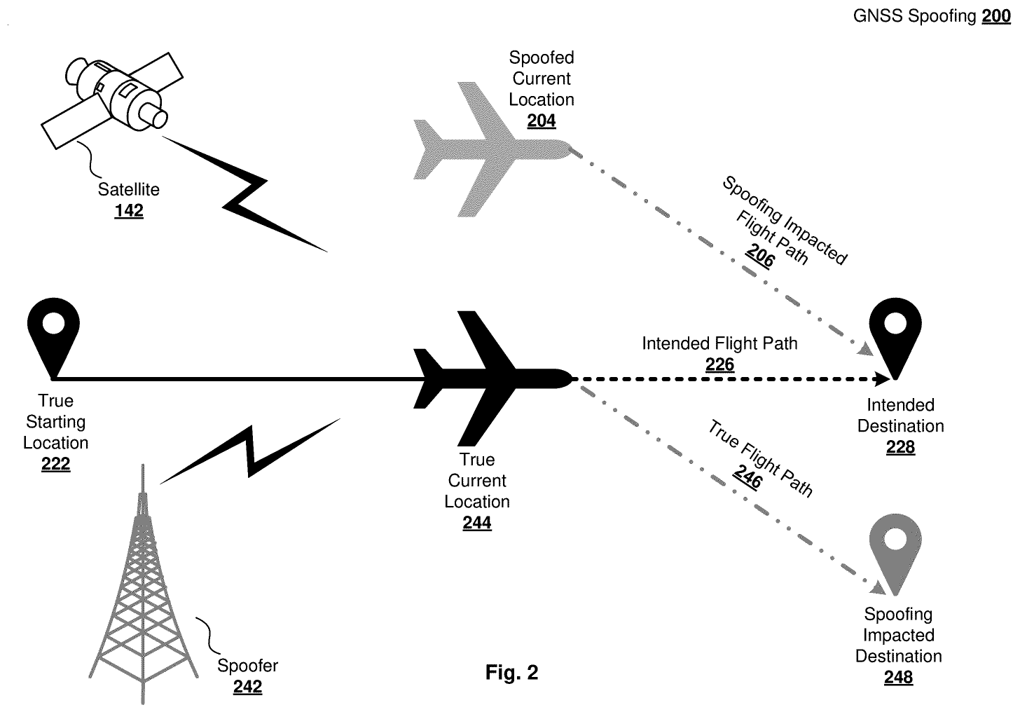

FIG. 2 shows an example schematic 200 of GNSS spoofing of aircraft guidance systems. Schematic 200 includes an aircraft traveling from a true starting location 222 to an intended destination 228, currently located at a true current location 244. The GNSS receiver of the aircraft receives GNSS signals for PNT guidance from source satellites 142a-n. A spoofer 242 has activated a spoofing attack, comprising the integrity of the aircraft's GNSS signals. The aircraft has a true current location 244. The spoofing interference causes the position of the aircraft to appear to the aircraft's GNSS system to be at the spoofed current location 204. As a result, instead of staying on the intended flight path 226 from location 244 to the destination 228, the aircraft's navigation system will attempt to guide the aircraft from the spoofed location 204 to destination location 228, shown as the spoofing impacted flight path 206 within schematic 200. Consequently, such navigation will take the aircraft from location 244 to the spoofing impacted destination 248 via the flight path 246 (e.g., ADS-B track data).

In addition to affecting the aircraft's navigation integrity, ADS-B out messages that report a spoofed GNSS position can impair ATC's ability to monitor air traffic to varying degrees. In some cases, a difference between the ADS-B out position and position determined by radar can lead to position errors or omissions in ATC systems. Moreover, outside of radar coverage, ATC is dependent on the GNSS position sent in the ADS-B out messages. A spoofed position results in ATC perceiving the aircraft at a different location than it actually is. Potential adverse scenarios include collision and near-collision events in “crowded sky” situations, impaired management of air traffic by ATC, and emergencies involving severe weather, plane hijackings or conflict zone airspace.

The example given in schematic 200 is an example provided for illustrative purposes. Impacts beyond what is illustrated in the figure are referenced above. No one will doubt that it is important to promptly detect such events and alert aircraft personnel of detected events in order to mitigate or entirely prevent high risk consequences. The technology disclosed includes distributed networks and methods for detecting and alerting aircraft of potential GNSS spoofing events that leverage existing EFB tablets onboard aircraft and a cloud-based alert system.

### Cloud-Based Detection and Alerts of GNSS Spoofing Events

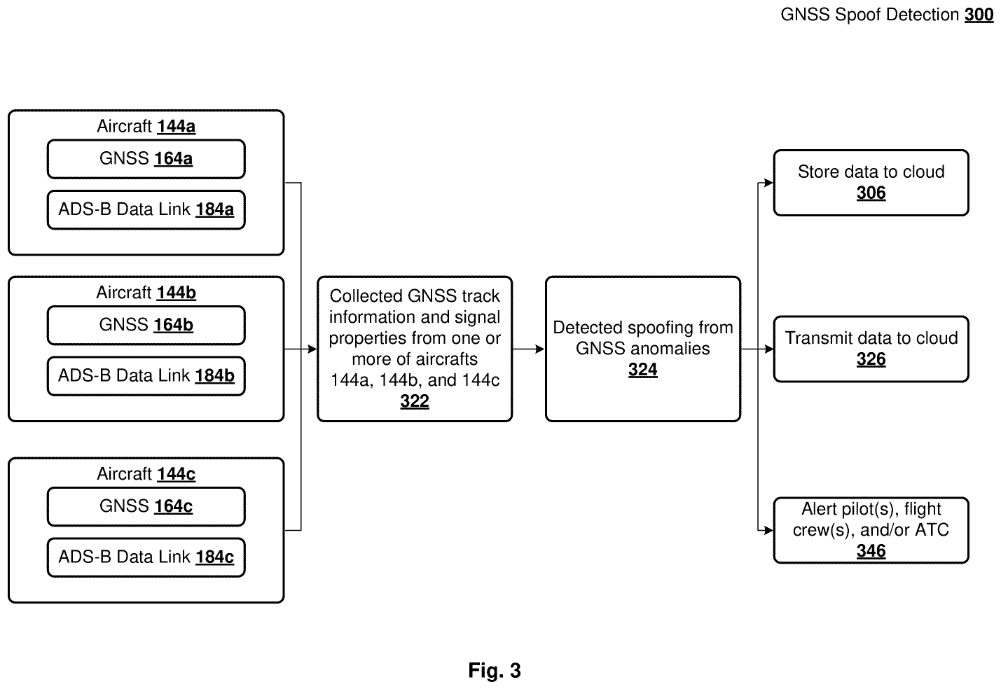

FIG. 3 shows a block diagram 300 for various cloud-based approaches of processing GNSS data to alert personnel to GNSS spoofing of aircraft guidance systems, according to one implementation of the disclosed technology.

Diagram 300 includes aircraft 144a, 144b, and 144c each containing certified avionics including a GNSS receiver 164a, 164b, and 164c, respectively, and an ADS-B data link 184a, 184b, 184c. In operation 322, GNSS track information and signal properties for at least one of aircraft 144a-c can be collected, and the collected data is analyzed within operation 324 to detect potential spoofing events from anomalies in the collected data. The GNSS data may be transmitted to a cloud-based server for processing (operation 326) or processed locally on an EFB device onboard the aircraft before being transmitted to the cloud-based server. The GNSS data is also stored to a cloud database in operation 306, along with additional metadata (e.g., aircraft operational limitations) and analysis outputs (e.g., detected spoofing). When a potential spoofing event has been detected, the cloud-based alert system can communicate an alert to aircraft personnel in-flight via the EFB tablet device onboard the aircraft, ATC, other GNSS users, etc., in operation 346.

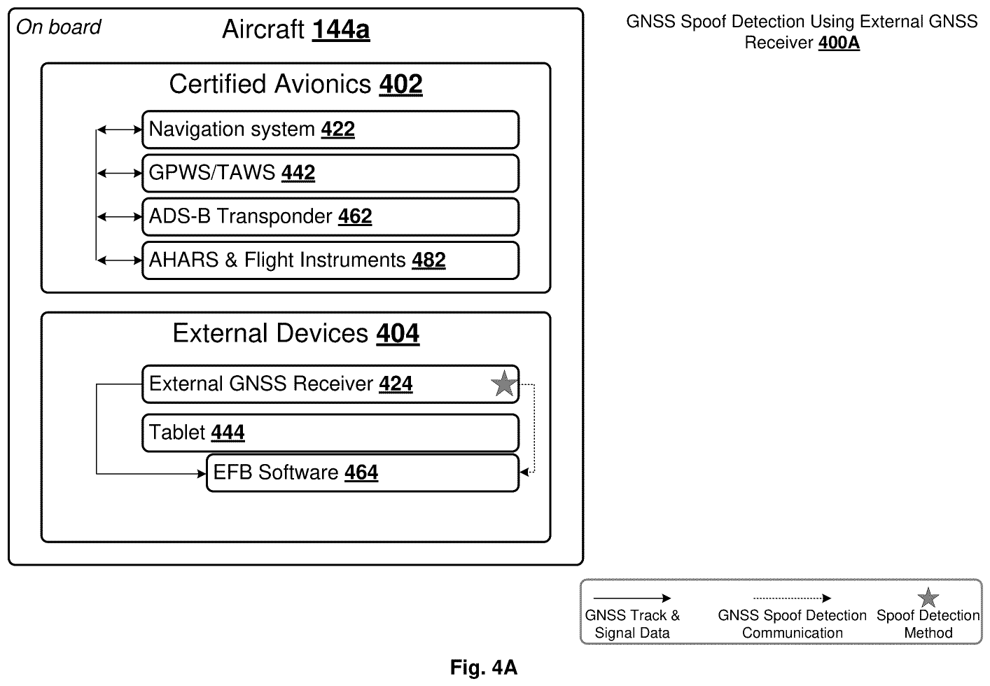

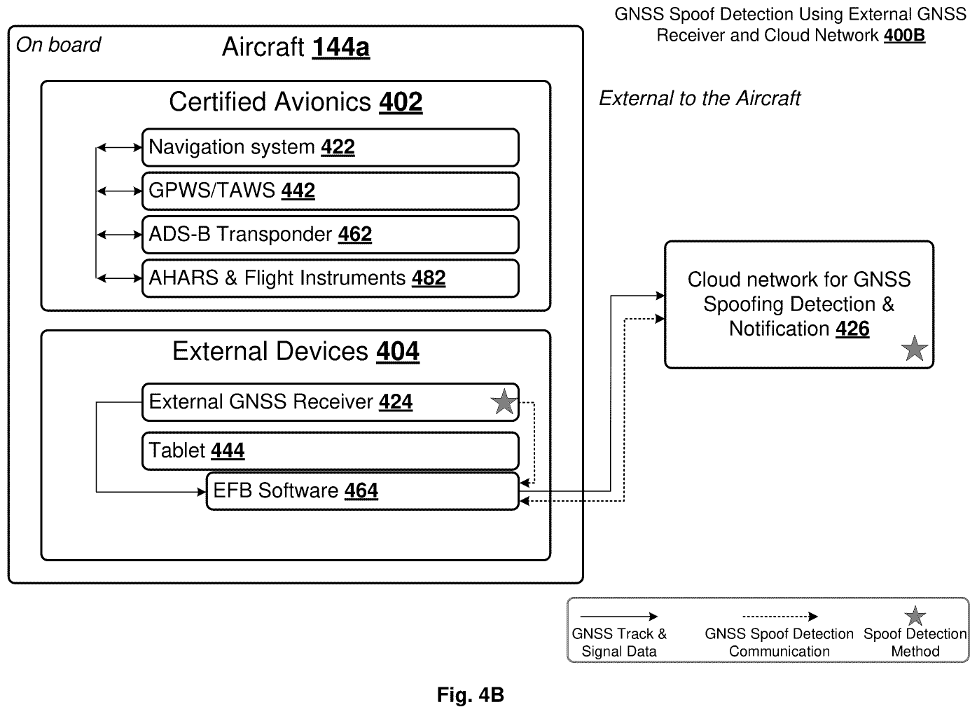

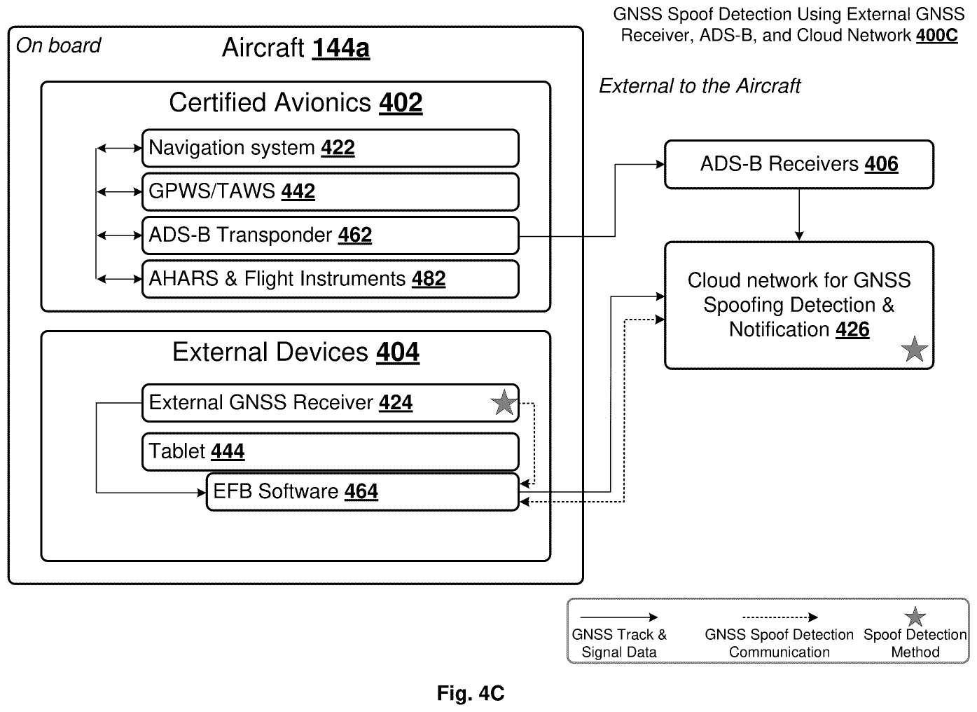

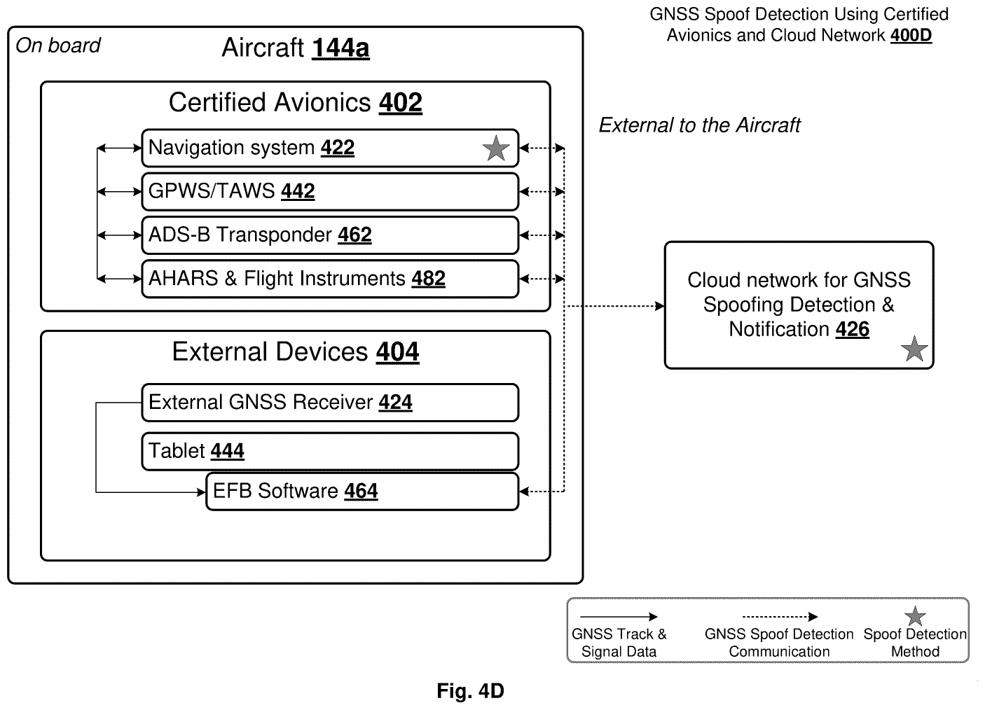

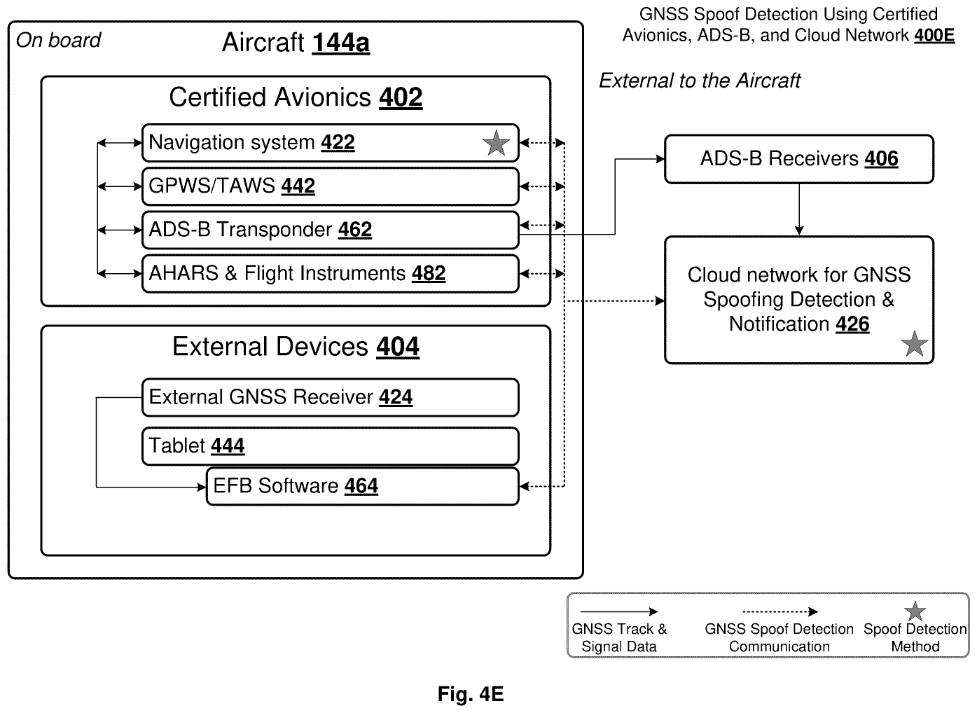

The collection of GNSS data for an aircraft 144 can be performed in a variety of ways according to different implementations of the technology disclosed. Certain GNSS data sources will briefly be summarized, then example implementations including collecting and detecting spoofing events within GNSS track data will be presented with reference to FIGS. 4A-4E.

GNSS track information for a particular aircraft may be obtained from ADS-B track data for the particular aircraft. The GNSS data collected by 164a for aircraft 144a is communicated to an ADS-B receiver network (e.g., ATC) via ADS-B data link 184a, and similarly for aircraft 144b and aircraft 144c. The transmitted ADS-B integrity, and the GNSS-integrity, track and position data is collected via a plurality of sources, including ATC and various crowd-sourced ADS-B data resources such as ADS-B Exchange and The OpenSky Network. From these sources, ADS-B integrity, and GNSS integrity, track and position data for an aircraft can be collected and processed using the cloud-based server (operation 326), stored to the cloud-based server (operation 326) and either analyzed for GNSS spoofing detection (operation 324) before transmitting data to the cloud, when connectivity to the cloud is not possible, or analyzed for GNSS spoofing detection (operation 324) by the cloud-based alert system itself.

In some implementations, aircraft 144a, for example, can be equipped with an external GNSS receiver that operates independently of the certified avionics GNSS receiver 164a. The external GNSS receiver can be linked to the EFB tablet or to other software running on hardware, which collects the GNSS data from the external receiver and transmits the data to the cloud-based server for processing, including analysis of the data for GNSS spoofing detection, and alert. In the interest of being concise, it should be understood that references to the EFB tablet device throughout this application as implementing the technology disclosed are considered to refer to EFB usage in any modality and also to supplemental systems other than EFB and even to integration of the technology disclosed into certified avionics, unless the context requires to the contrary. The data being analyzed may include GNSS integrity, track and position data and/or GNSS signal properties. In one implementation, the GNSS data received is from the internal GNSS receiver of the EFB tablet device. In other implementations, the EFB tablet receives GNSS data from the certified avionics GNSS receiver 164a and transmits the certified avionics GNSS data to the cloud-based server for GNSS spoofing detection and alert. For either the certified avionics or an external GNSS receiver, the spoofing detection may be performed locally and transmitted to the cloud-based server at a later time (e.g., if connectivity is not possible at the time of data collection) for further processing and storage, or the EFB tablet device may transmit the data to the cloud upon receipt for detected spoofing alerts in closer to real-time.

Analysis of ADS-B/GNSS integrity, track and position data from ADS-B data sources or an onboard GNSS receiver (within, or external to, the aircraft's certified avionics) can include identification of one or more flight path abnormalities for the aircraft. An anomalous flight path characteristic can be, for example, a detected jump in position along a flight path segment that exceeds an airspeed limitation for the aircraft, a detected movement along the flight path segment that exceeds the airspeed limitation for the aircraft or a minimum turn radius limitation for the aircraft, a turn performed exceeding a range of 1.5-3 degrees per second, a change in speed greater than 10 knots/second, or a change in altitude greater than 6000 feet/minute. A movement along the flight path that exceeds the aircraft's airspeed limitation can be calculated by comparing a pair of latitude and longitude reports and determining that the difference in position over time exceeds an airspeed limitation for the aircraft. Alternatively, position changes can be smoothed over multiple reports of latitude and longitude. Other criteria can be applied, such as a GNSS reporting of a turn performed exceeding 1, 2, or degrees per second or a threshold in a range of 1-3 or 2-3 degrees per second. One approach to calculating a turn from GNSS reporting can be:

```
instant heading diff (in degrees) = abs(instant_heading0 − instant_heading1)
where instant_heading is between two reported GPS latitude and longitude points.
Average heading diff rate (in degrees per second) =
  average_heading_diff/average_time_delta,
where average_heading_diff = Average heading difference over X GPS locations,
  average_time_delta = average from X pairs of GPS locations, X can be dynamic <=5
```

Another criteria can be a change in speed greater than a threshold of 7.5, 10 or 12.6 knots/second or a threshold in a range of 7-15 knots/second. A change in altitude threshold can be greater than 4000, 4500 or 5000 feet/minute or in a range of 4000 to 7000 feet/minute. These examples of anomalous flight path characteristics are not limiting, and a user skilled in the art will recognize that other anomalies in the GNSS integrity, track and position data may also be identified to indicate that a potential spoofing event has occurred.

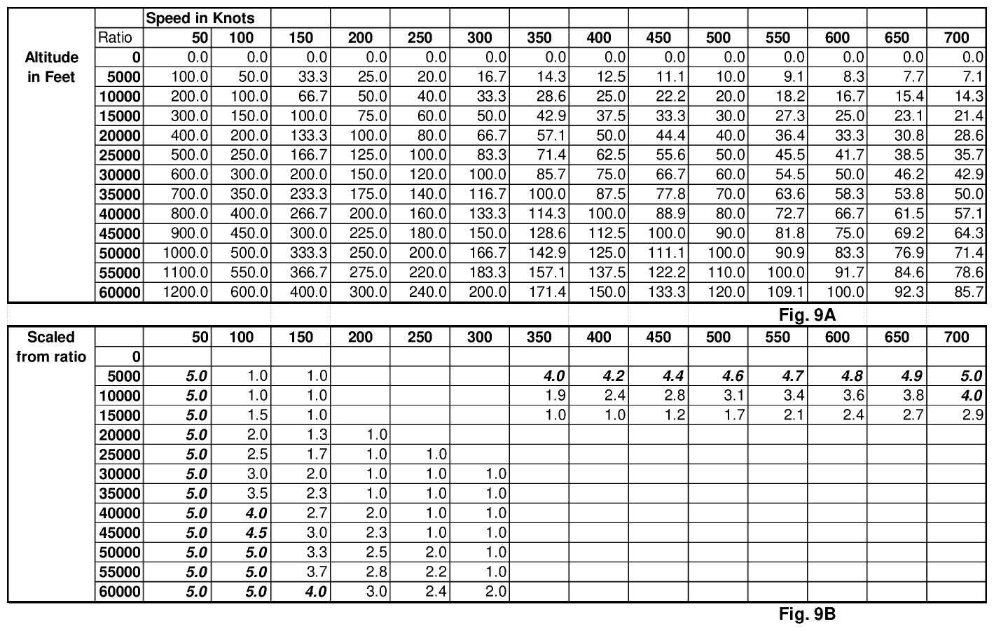

Another metric for identification of spoofing is a ratio of barometric altitude divided by GNSS groundspeed. One of skill in the art will understand the illustrative numbers and ratios that follow to be predetermined thresholds, scores, speeds, altitudes or boundaries. For example, a predetermined ratio, such as 500 or higher, can be used as a spoofing indication. Other thresholds such as 400, 300 or a value in a range of 200-500 also can be used. Ratios can be translated to scores in a range of 1-5 or some other chosen range, as shown in FIGS. 9A and 9B. Scaling of the score can take into account implausibly slow speeds, speeds that are too slow for high altitude flight, and speeds that are too fast for low altitude flight. In the scaling system illustrated, a high score is most likely spoofed; a score of 5 is treated as spoofed. A score of 3 or 4 also may be treated a spoofed. The scaling from FIG. 9A to FIG. 9B applies the following approach. A groundspeed below 50 knots at any altitude above the ground has a score of 5, because aircraft cannot fly slow, especially at high altitudes. In FIG. 9B, a ratio of altitude in feet divided ground speed in knots above 500 has a score of 5. For groundspeeds below 150 knots the ratio divided by 100 is the score (with a lower limit of 1). As an example, 20,000 feet at 100 knots, would be a score of 2.

For groundspeeds above 150 knots and below 300 knots, the ratio divided by 100 is the score (any result below 2 is considered a score of 1). Example 30,000 feet, 200 knots, would be a score of 1.

Aircraft are typically limited to 250 knots airspeed below 18,000 feet. Allowing for wind, scaling for any groundspeed above 350 knots and below 18,000 feet the score can be calculated with a ratio as (-(barometric altitude/groundspeed)/7) +6. Any score less than 1 is scored as 1, such as 350 knots at 15,000 feet.

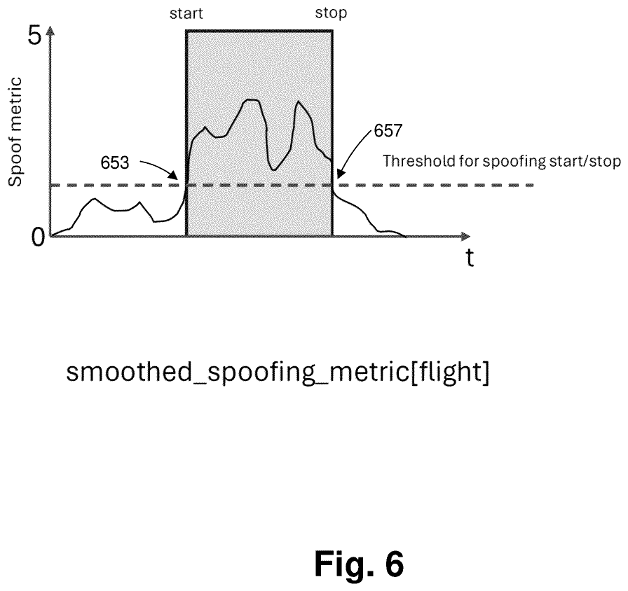

FIG. 6 is a graph of a time series of scaled barometric altitude ratio detecting a spoofing start 653 and spoofing stop 657. The scaled ratio includes a term that cannot be spoofed, the barometric altitude, which is measured independently of any GNSS technology. The ratio term barometric altitude or barometric altitude above takeoff altitude is useful because cruising speed is higher at altitude than during takeoff or landing. One artifact sometimes resulting from GNSS spoofing is reporting a reduced groundspeed and even a turn profile during straight and level flight. This ratio picks up the reduced groundspeed report from a spoofed GNSS, as shown in FIG. 6. When GNSS spoofing of the craft started, indicated by the left hand vertical line 653, the ratio changed significantly. When it stopped 657, the ratio again changed significantly.

Alternatively, spoofing could be identified using a ratio of pitot airspeed and GNSS groundspeed. Pitot airspeed is measured by sensing ram air pressure in a tube exposed to air flowing over the aircraft, independently of any GNSS technology. A variation of more than 1.5× between the two speed measurements can be used as a spoofing indication. Other ratios such as 140 to 200 percent or any ratio in that range also can be used as a threshold for detection of spoofing.

The GNSS signal data received by the certified avionics or an external GNSS receiver can also be analyzed to identify one or more abnormal signal properties. An anomalous signal characteristic in the GNSS signal data may be, for example, an anomalous signal strength of satellite signals compared to other received satellite signal strengths, an anomalous signal strength of satellite signals for an elevation and azimuth of source satellites, an anomalous elevation or azimuth of the satellite signals, an anomalous pseudo range of the satellite signals, an anomalous clock stability of the satellite signals, anomalous time codes of the satellite signals compared to other received satellite signals, incorrect, missing, or null values in the GNSS signal data, an anomalous change to broadcast almanac data, an anomalous change in AGC input levels, or a loss of usable GNSS signals followed by the anomalous signal characteristic. Signals can be monitored for any combination of one or more of these anomalies.

In some implementations, GNSS data can be collected from a plurality of data sources for the aircraft and data from different sources can be compared to one another to identify anomalous data values. This can include, for example, comparing the ADS-B track to the GNSS track from an external GNSS receiver, comparing GNSS track or GNSS signal properties from the certified avionics to that of the external GNSS receiver, comparing GNSS track and position data to the expected flight path track and position data, or comparing GNSS data between different satellite constellations, to identify nonsimilar data values between the compared data sources. In one implementation, ADS-B track and position data obtained from collected ADS-B communication data can be compared to the GNSS track and position data obtained from an external GNSS receiver onboard the aircraft to identify dissimilar values indicative of a spoofing event, such as the ADS-B track and position data showing the aircraft on a different flight path than the GNSS track and position data. The ADS-B track and position data can also be compared to the certified avionics GNSS track and position data in addition to, or instead of, comparing the ADS-B track and position data and the external GNSS receiver track and position data. In another implementation, a similar comparison analysis can be performed using the certified avionics GNSS track and position data and the external GNSS receiver track and position data. Alternatively, signal characteristics like elevation, azimuth, or clock stability can be compared between the certified avionics GNSS data and external receiver GNSS data. Some implementations include a comparison of in-flight GNSS track and position data, collected from ADS-B track and position data, the certified avionics, and/or an external GNSS receiver, with the expected flight path of the aircraft to identify deviations from the expected navigation route. In another implementation, GNSS data from different satellite constellations, like GPS versus GALILEO, can be compared. In implementations involving the comparison of GNSS data from two or more sources, anomalous data may be identified by detecting a deviation/dissimilarity in paired, contrasted values from each respective source that exceeds a pre-defined acceptable threshold value.

In other implementations, GNSS data can be collected from a plurality of data sources for different aircraft for comparison to one another to identify anomalous data values, or to determine the region that is affected by a detected spoofing event. The data collected within a particular region for one or more aircraft may be collected all within an overlapping time period (in near real-time or historically) or from different time periods to analyze GNSS interference data for trends over time.

Some aircraft after exiting a spoofed area continue to have residual problems with their GPS that can be observed in the ADS-B data. Either a cloud-based server or an Electronic Flight Bag (EFB) tablet can be used to analyze the ADS-B data. A vulnerable aircraft, experiencing residual issues after spoofed, can be determined based on false recurrence of spoofing or a low navigation integrity score. The first indicator of residual GPS problems is reporting of a spoofing_start and spoofing_stop after the aircraft has exited a spoofed area, in an area that other aircraft do not report as spoofed, applying analysis described throughout this application. This sometimes happens to an aircraft that already has been spoofed at least once in a flight. Second, an aircraft may have a network integrity score of category 3 or worse, at an accuracy estimated to be accurate within <4 NM, after exiting a spoofed area. Other thresholds such as category 2 or within <6 NM or <8 NM or <10 NM limit of accuracy or in a range between two of those limits of accuracy could be used. Either or both of these criteria can be used to detect residual issues. Reports from aircraft with residual GPS/GNSS problems after spoofing can be filtered out of and not considered by processes for spoof area mapping.

### Mapping Boundaries of Spoofing

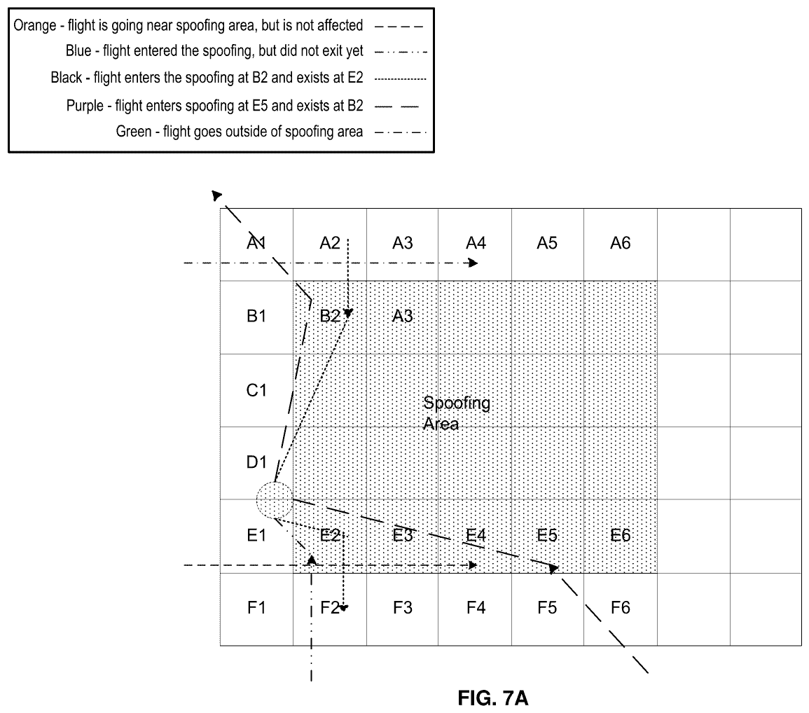

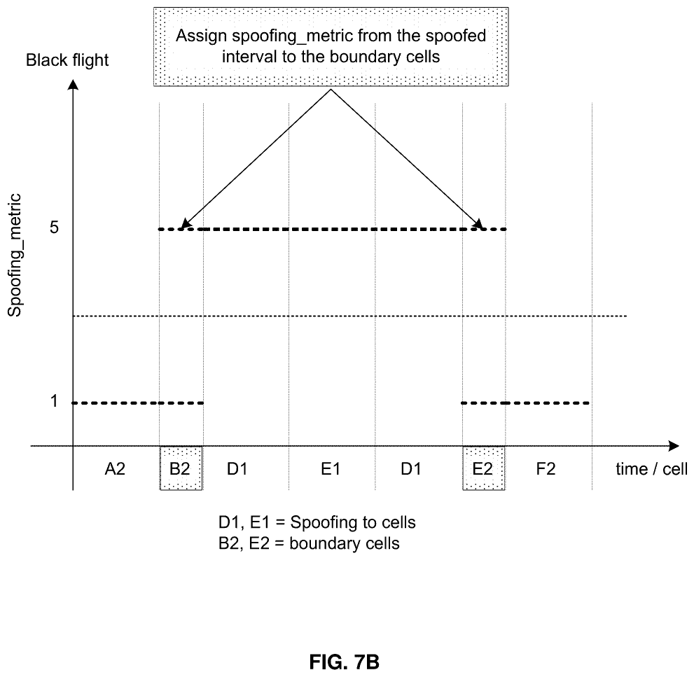

A region that includes a spoofing area can be mapped by applying a variety of approaches. FIG. 7 illustrates one approach that uses spoofing_start and spoofing_end locations reported by flights through the region. For analysis, the airspace of the Earth can be divided into polygons two dimensionally, so that an aircraft flies from one polygon to another. As the aircraft travels across a polygon the aircraft spoofing metrics can be used to generate a spoofing metric for each polygon. Determining the boundary of a spoofing area can begin with collection of all of the flight metrics for polygons (e.g., A1 . . . F6 in FIG. 7A) that overlay a map of the region from the last time period, such as 24 hours, 12 hours, 6 hours or any period in a range of 4 to 48 hours or more. From the data, spoofed flights are the flights that recorded either a spoofing_start or a spoofing_stop in the region. Of the five flights in FIG. 7A, three flights named blue, black and purple reported spoofing, two of which traversed the spoofing area and one of which entered but has not yet left the spoofing area. Two flights named orange and green did not experience spoofing. In FIG. 7B, spoofing boundary cells B2 and E2 are identified for the flight that entered the region at A2 at the top and left via F2 at the bottom. The particular polygons in which a spoofing_start or a spoofing_stop was reported are noted from the spoofed flights that traversed the region. See, FIG. 7C for boundary cells B2, E2 and E5. The spoofing_start and spoofing_stop locations can be based on where a metric crossed a threshold set to separate spoofing from not. Start and stop times also can be noted for the particular polygons where spoofing started and stopped for a particular flight.

Aircraft within a boundary of spoofing will not transmit a reliable location. In fact the location reported may not be anywhere near the actual area where spoofing takes place. Hence, only a boundary can be identified and the polygons within the boundary polygons are assumed to be inaccurate due to spoofing. It is possible that aircraft report a position when it is within a spoofed area, but any report should not be trusted. For example, cells D1 and E1 in FIG. 7C, are “spoofed to” locations. Those polygons are not trusted as actual locations of the aircraft being spoofed. Reports of aircraft locations D1 and D2 while traversing the spoofed area are disregarded, because they are spoofed, not actual aircraft locations.

Optionally, instant spoofing metric values can be calculated for intervals when a flight is being and not being spoofed. E.g.,

(from spoofing_start to spoofing_stop): spoofing_metric[polygon_ID, spoofed_flight]=
sum(instant_spoofing_metric[flight]) / (time_stop − time_start).

Similar metrics can be calculated for non-spoofed flights traversing the region, which were not between a spoofing_start and a spoofing_stop report while they were in particular polygons. To calculate the polygon's average instant_spoofing_metric while a non-spoofed flight is within the polygon:

spoofing_metric[polygon_ID, non_spoofed_flight]= sum(instant_spoofing_metric[flight]) /
(time_enter_polygon− time_exit_polygon).

Using either the start and stop polygons for individual flights or per-polygon spoofing metrics, a list of boundary polygons is compiled. For at least each of the boundary polygons, all of the flights traversing the polygon register a spoofing value for their traversal interval: spoofing_metric [polygon_ID, flight]. Using the number of flights that traversed the polygon, a spoofed flight ratio for each polygon can be calculated. More details of selecting boundary polygons are describe in the next approach, below.

Alternatively, clusters of spoofing_start datapoints could used in hybrid approach determine the ratio of spoofed aircraft to aircraft that are operating normally within a polygon and use a MST to connect the polygons into a spoofed area.

Mapping out spoofed polygons can be performed for different barometric altitudes to provide a three dimensional picture of spoofing. For instance, altitude bands of 1 to 10,000 ft, 10,000 to 18,000 ft, 18,000 to 24,000 ft and above 24,000 ft could be mapped and then combined to refine a spoofing map from two dimensional to three dimensional. More or fewer bands, in a range of 3 to 10 bands or a subrange within that range could be used.

Mapping of spoofed areas also can be represented as ellipses or circles. Ellipses can be plotted by determining a major and minor axis of a spoofed area and using those axes or a factor of those axes to plot an ellipse. Other techniques for superimposing an ellipse on a polygon or rectangle also can be applied. An ellipse will be expected to represent radiated coverage of a spoofing source because even directional broadcast emanate a signal that is more nearly an ellipse than a rectangle.

Some sample points could be excluded from analysis. We could exclude takeoff and landing aircraft, based on their flight profile, including ground speed and barometric altitude. We could exclude aircraft that are hovering: average_airspeed lower than 25 knots for over 20% of the data points in a polygon at an altitude greater than 1000 feet above the ground altitude. We could also exclude outlier reports, especially where more than half, two-thirds or three-fourths of the aircraft passing through an outlier region did not report spoofing. Single aircraft reports might be held for confirmation by experience of spoofing or might be published as potential instead of confirmed spoofing.

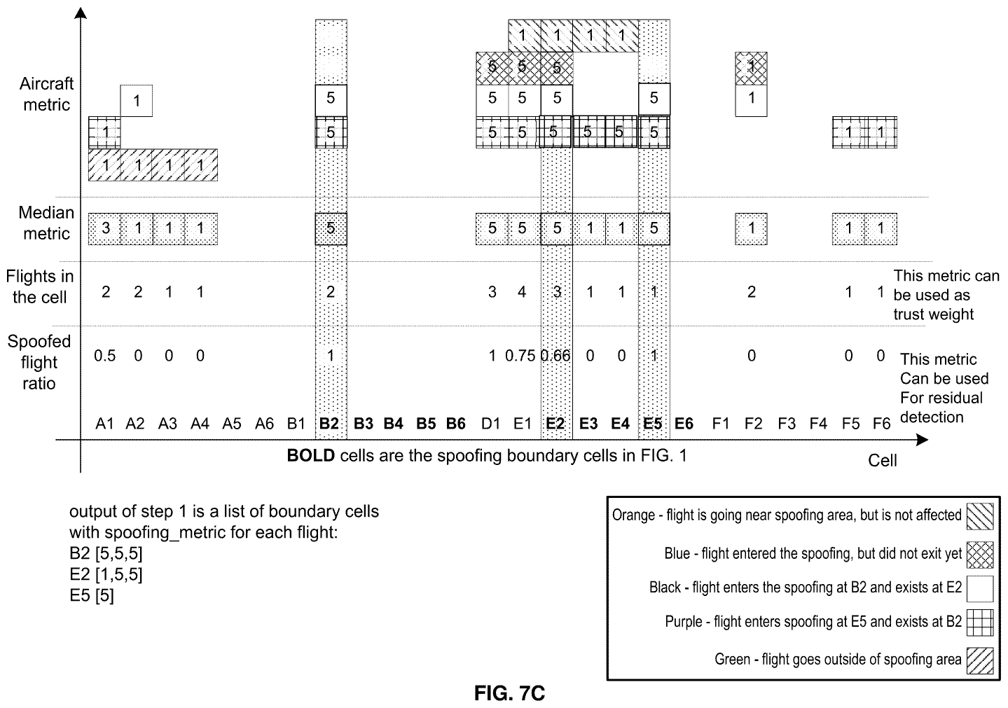

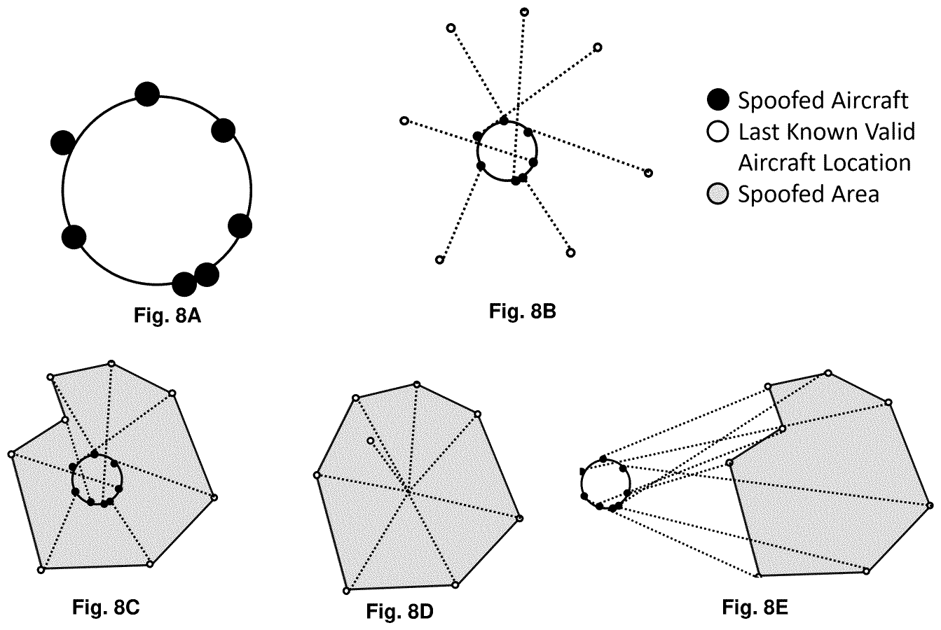

From the list of boundary polygons, a spoofing area can be mapped. FIG. 7 makes it clear that multiple flights are required to construct an accurate boundary of a spoofing region. There are not enough flights in FIG. 7 to map the upper and right hand borders of the spoofing area with certainty. More flights are depicted in FIG. 8.

Another approach relies on spoof start but not stop locations, as illustrated in FIG. 8A-E. Step 1 in FIG. 8A: Identify a ‘spoofed to location’ that contains multiple aircraft that have become spoofed. These clusters typically have multiple aircraft because a spoofer radiates a signal that spoofs large areas. Most of the aircraft in that area will become spoofed and will report their location in the same “spoofed to” area. Note, The shape of the spoofed area may not be a circle, it can be other shapes and/or a concentrated area of aircraft in this ‘spoofed to location.’ Step 2 in FIG. 8B: Trace each aircraft in this ‘spoofed to location’ back to their ‘last known valid location.’ Note that the spoofed to location can be substantially removed from the last known valid location, without the aircraft having travelled very far. In this approach, we do not trace from the ‘spoofed to location’ to the ‘spoofed stop location’ where the aircraft resumes normal GPS behavior and location reporting. Due to the variability of the time it takes for an aircraft's GPS to recover after spoofing, if it recovers, to pilot intervention, and to ADS-B coverage, the ‘spoofed stop location’ is not a good indication of the extent of the spoofer's radiation pattern or of the ‘spoofed area’. Step 3 in FIG. 8C: Connect the dots. Draw lines to connect the ‘last known valid location’ to create an outline of the ‘spoofed area.’ Alternatively, we can use the locations of each flight's spoof_start with a minimum spanning tree clustering method to determine the a spoofed area regardless of polygons. Construct a Minimum Spanning Tree (MST) from the spoofing_start data points, where each edge represents the distance between two spoofing_start points. Analyze the MST to identify “inconsistent” edges (usually based on their length) and remove them, which results in separate connected components representing clusters where aircraft began to be spoofed. The “clustering spoofed area” is the set of spoofing_start data points within a single connected component after removing inconsistent edges. Optional step 4 in FIG. 8D: Adjust the size of the ‘spoofed area’ to account for the furthest distance an aircraft was spoofed. From the center of the ‘spoofed area’ segment the area into sections (example every 10 degrees) and use only the furthest ‘last known valid location.’ Alternatively, spanning tree and other methods can be used to smooth the ‘spoofed area’ shape. Note the spoofed area may not have as its center the ‘spoofed to location.’ As shown in FIG. 8E, the ‘spoofed to location’ can be entirely outside the ‘spoofed area.’ A spoofer can spoof aircraft to anywhere on Earth. For example, a spoofer in Ukraine could spoof aircraft to report being in America.

When a potential spoofing event is detected within the data, in response to one or more anomalous flight path characteristics, anomalous signal characteristics, inconsistencies in the GNSS data, or anomalous patterns identified in the GNSS data across a plurality of aircraft and/or over a period of time, the potential spoofing event can be communicated to an aircraft via the EFB tablet on board to inform aircraft personnel of the detected spoofing. The spoofing alert may also be communicated to, for example, other aircraft or ATC. In one implementation, an aircraft may be warned when it is about to enter a region where spoofing may occur, notified of when the aircraft has left the region, or notified of when a detected spoofing event has ceased.

Data collected within the cloud database can undergo further analysis, such as processing by a deep learning classifier. The collected GNSS data, related metadata, ground truth classifications, and/or cloud processing outputs can be used as training data for the deep learning classifier. Input features can include PNT values from the collected GNSS integrity, track and position data as defined above, GNSS signal characteristics, date and time data, metadata associated with the aircraft including operational limitations or specifications, and/or descriptive statistics and pre-processing outputs obtained from these input features like mean/minimum/maximum values, reduced dimensionality datasets from principal component analysis, and so on. In some implementations, the input data includes values collected from a plurality of sources for the same aircraft, such as two or more of the ADS-B integrity, and the GNSS integrity, track and position data, the certified avionics GNSS receiver integrity, track and position data, and external GNSS receiver integrity, track and position data. In certain implementations, the input data includes data collected for a plurality of aircraft. Ground truth labelling for training data can include whether a GNSS interference event was detected in response by analysis of the collected GNSS data and related metadata, a classification of the GNSS interference event (e.g., spoofing or jamming, malicious or accidental error, etc.). The classifier may be trained, for example, to detect spoofing events, identify predictors of spoofing events, classify types of spoofing events, and so on.

FIGS. 4A-E illustrate various particular implementations of GNSS spoofing detection. Within FIGS. 4A-E, collection of GNSS track and signal data is indicated by solid arrows, while data communication for processing and alert of detected GNSS spoofing is indicated by dotted arrows. The spoofing detection approach is indicated by a star.

FIG. 4A shows a block diagram 400A for GNSS spoofing detection using an external GNSS receiver 464, according to one implementation of the technology disclosed. Diagram 400A shows an aircraft 144a including certified avionics 402 and external devices 404. The certified avionics 402 include, for example, a navigation system 422, GPWS/TAWS 442, an ADS-B transponder 462, and AHARS/flight instruments 482. External devices 404 include an external GNSS receiver 424 and a tablet 444 configured to run EFB software 464. GNSS data from the external GNSS receiver 424, such as GNSS track and/or signal data, is collected and processed for spoofing detection, as indicated by the star icon. The external GNSS receiver 424 is linked to tablet 444, enabling analysis of the GNSS data for spoofing detection using EFB software 464. In some implementations, analysis is performed by an application running on tablet 444. In other implementations, the external GNSS receiver 424 is configured to perform spoofing detection, and notifies the aircraft personnel, via EFB 464, of a detected spoofing event.

FIG. 4B shows a block diagram 400B for GNSS spoofing detection using an external GNSS receiver 424 and a cloud-based alert system 426 for GNSS spoofing detection and notification. Diagram 400B contains many of the same components as diagram 400A, which will not be repeated here for the sake of conciseness and clarity. However, diagram 400B further includes a cloud-based server including a cloud-based alert system 426. GNSS spoofing detection is performed by analysis of the GNSS signals from external GNSS receiver 424 by the cloud-based alert system 426, as indicated by the star icons. In addition to the processes described in diagram 400A, the collected GNSS data from external GNSS receiver 424 may also be transmitted by EFB 464 to the cloud network for cloud processing, and the cloud-based alert system 426 communicates an alert of potential detected GNSS spoofing back to the EFB 464.

FIG. 4C shows a block diagram 400C for GNSS spoofing detection using an external GNSS receiver 424, ADS-B receivers 406, a cloud-based alert system 426 for GNSS spoofing detection and notification. Diagram 400C contains many of the same components as diagram 400B, which will not be repeated here for the sake of conciseness and clarity. However, diagram 400B further includes a network of ADS-B receivers 406. In addition to cloud processing of GNSS signals from the external GNSS receiver 424, the ADS-B integrity, and the GNSS integrity, track and position data communicated from the ADS-B transponder 462 to the ADS-B receivers 406 can also be collected and analyzed, as described above. The ADS-B data and external GNSS data may be compared to one another, analyzed separately, or aggregated for analysis.

FIG. 4D shows a block diagram 400D for GNSS spoofing detection using GNSS data obtained from certified avionics 402 and a cloud-based alert system 426 for GNSS spoofing detection and notification. Diagram 400D contains many of the same components as diagram 400B, which will not be repeated here for the sake of conciseness and clarity. In diagram 400D, GNSS track and signal data from the certified avionics 402 are also collected and communicated to the cloud-based alert system 426 for spoofing detection and alert. The certified avionics data and external GNSS data may be compared to one another, analyzed separately, or aggregated for analysis.

FIG. 4E shows a block diagram 400E for GNSS spoofing detection using GNSS data obtained from a plurality of GNSS receiver sources and a cloud-based alert system 426 for GNSS spoofing detection and notification. Diagram 400E contains many of the same components as diagram 400C, which will not be repeated here for the sake of conciseness and clarity. In diagram 400E, GNSS track and signal data may be collected from the certified avionics 402, ADS-B network 406, and/or the external GNSS receiver 424 and communicated to the cloud-based alert system 426 for spoofing detection and alert. The certified avionics data, ADS-B data, and external GNSS data may be compared to one another, analyzed separately, or aggregated for analysis.

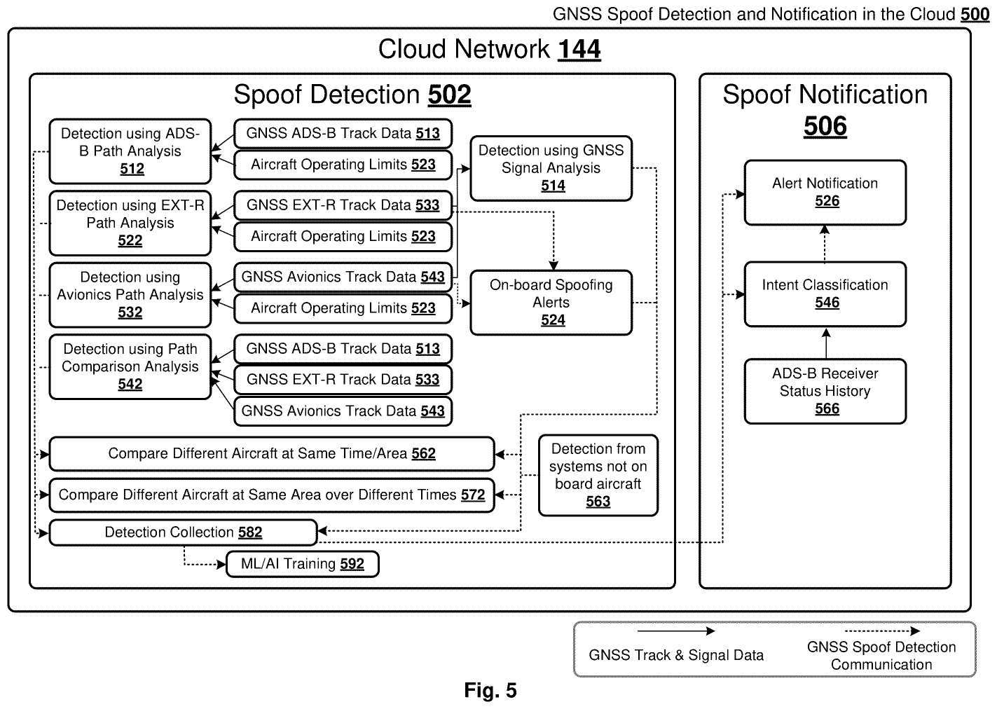

FIG. 5 shows a block diagram 500 for a distributed network configured to analyze global navigation satellite system (GNSS) interference data from a plurality of GNSS receiver sources to detect spoofing events impacting a plurality of aircraft. Cloud network 144 of diagram 500, including a cloud-based alert system, is configured to perform spoofing detecting 502 and spoofing notification 506. Spoofing detection may be performed using ADS-B path analysis 512, including the processing of GNSS ADS-B track data 513 and aircraft operating limits 523.

Spoofing detection may be also performed using external GNSS receiver path analysis 522, including the processing of external GNSS receiver track data 533 and aircraft operating limits 523. Spoofing detection may be also performed using certified avionics path analysis 532, including the processing of external certified avionics track data 543 and aircraft operating limits 523. Spoofing detection can be performed using GNSS signal analysis 514, including the processing of external GNSS receiver track data 533 and/or external certified avionics track data 543. A combination of GNSS ADS-B track data 513, external GNSS receiver track data 533 and/or external certified avionics track data 543 can be used for spoofing detection using a path comparison analysis 542. On-board spoofing alerts may be performed from analysis of external GNSS track data 533, GNSS avionics track data 543, and/or GNSS signal analysis 514. GNSS data may be compared from different aircraft at the same time in the same region 562, or at the same area over different times 572.

The collected data, as well as data associated with any detected spoofing, is collected and stored in a cloud database 582. Collected data may be used for alert notification(s) 526 to one or more aircraft, ATC, or other GNSS users. The collected data can be leveraged for intent classification of the spoofing attack, as well as analyzed in combination with ADS-B receiver status history 566 to further inform intent classification 546. In one example, if an ADS-B receiver history shows that the receiver operation overlaps with a history of one or more spoofing events, it can be inferred that the spoofer is using that ADS-B receiver in their attack. Furthermore, collected data may be used for ML training processes 592, as described previously.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein. The scope of the technology disclosed is defined by the appended claims.

### Cloud-Based Detection and Alerts of GNSS Jamming Events

A GPS jammed area can more easily be calculated than a spoofed area because once a flight is jammed it does not report a false position, only a degraded estimate of its position or no position at all. In addition, when a flight is jammed the ADS-B Navigation Integrity Category (NIC) value of 0 as an indication of jamming. A value equal to or worse than (below) 4, can be an indication of a jammed flight. One can look at a moving window of the last three reported NIC data points to filter out false positives. One also can look at the density of aircraft with similar NIC values in the same area to determine if the area is jammed and filter out errors being transmitted by aircraft. Alternatively, a NIC value threshold of 3, 5, 6 or greater could be used. Or an estimated location accuracy could be used instead of a categorical representation of NIC. In versions 1 and 2 of NIC parameters, the accuracies represented by these categories are 3 means an accuracy of <4 NM, 4 means an accuracy of <2 NM, 5 means an accuracy of <1.0 NM and 6 means an accuracy of <0.5 NM.

### Some Particular Implementations

We describe some particular implementations and features usable for providing detection and alert of GNSS spoofing and jamming.

We describe some particular implementations related to the use of ADS-B data, GNSS track and position data, and/or GNSS signal data collected by ADS-B networks, certified avionics, and/or external GNSS receivers corresponding to one or more aircraft.

One implementation includes a disclosed method of cloud processing for automatic dependent surveillance-broadcast (ADS-B) data to alert aircraft personnel to GNSS spoofing of aircraft guidance systems. The method further includes receiving at a cloud-based server, from one or more ADS-B data sources. The ADS-B data can include some or all of ADS-B integrity, and GNSS integrity, track and position data for an aircraft. The method includes analyzing the GNSS track and position data upon receipt. Analyzing can include comparing the GNSS track and position data to a plurality of operational limitations for the aircraft and/or identifying an anomalous flight path characteristic from the analyzed GNSS track and position data. Comparison of track data to operational limitations is a significant improvement on prior spoofing detection. In response to an identified anomalous flight path characteristic, the cloud-based server can provide an alert to an Electronic Flight Bag (EFB) tablet device or other system, such as software running on hardware, causing notification of aircraft personnel of a potential spoofing event. Causing notification can either be direct, such as generating a message, an icon, a warning light or an audible signal. Or, it can involve sending a message to a connected system that alerts the aircraft personnel. The aircraft personnel can be the pilot, co-pilot, navigator, engineer or someone else onboard who is responsible for safe or reliable operation of the aircraft. An anomalous flight characteristic may include one or more of a detected jump in position along a flight path segment that exceeds an airspeed limitation for the aircraft, a detected movement along the flight path segment that exceeds the airspeed limitation for the aircraft or a minimum turn radius limitation for the aircraft, a turn performed exceeding a range of 1.5-3 degrees per second, a change in speed greater than 10 knots/second, or a change in altitude greater than 6000 feet/minute. Alternative thresholds and ranges for thresholds are given above.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

For some implementations, the ADS-B data for the aircraft is transmitted by an ADS-B transponder onboard the aircraft, received by ADS-B receivers, and collected by a plurality of ADS-B data sources including crowd-sourced ADS-B data services and air traffic control systems.

For some implementations, the method further includes providing an alert of potential spoofing in a specific area to other aircraft via onboard EFB tablets, an air traffic control base station, or other GNSS users via a cloud-based connection. It also can further include providing an alert of potential spoofing in a specific area to EFB tablets, airline dispatch systems, ground maintenance systems, and other preflight, inflight, and post flight systems via a cloud-based connection. Notification to maintenance can prompt trained personnel to anticipate arrival at a gate of an airplane that is suffering residual effects. This can reduce turn-around time for impaired aircraft. Notification to maintenance also can be used to identify particular avionics systems as more susceptible to residual effects than other systems, to differentiate among systems by vulnerability.

In addition to track and position data, implementations can include receiving at the cloud-based server ADS-B integrity and GNSS integrity data. The alert and notification of aircraft personnel to the potential spoofing event can be escalated when the received ADS-B integrity and GNSS integrity data indicates high integrity that will not trigger a data integrity warning to the aircraft personnel.

For some implementations, the method further includes storing one or more of the ADS-B integrity, and the GNSS integrity, track and position data, with corresponding aircraft limitations, to a cloud storage for detected spoofing events.

For some implementations, the method further includes training a deep learning model, using the stored ADS-B integrity, and the stored GNSS integrity, track and position data and corresponding aircraft limitations, to process the ADS-B integrity, and the GNSS integrity, track and position data and generate, as output, a classification of the ADS-B integrity, and the GNSS integrity, track and position data as affected or unaffected by spoofing. In some implementations, the trained deep learning model is further trained to generate, as output, a classification of a detected interference event within the ADS-B integrity, and the GNSS integrity, track and position data.

For some implementations, the method further includes receiving one or more of ADS-B integrity, and GNSS integrity, track and position data for a plurality of aircraft, analyzing the ADS-B integrity, and the GNSS integrity, track and position data for the plurality of aircraft, and comparing the analyzed ADS-B integrity, and the GNSS integrity, track and position data across the plurality of aircraft to determine an area impacted by a detected spoofing threat, a size of the impacted area, and an expected impact on different types of GNSS systems. Integrity data is optional, as many detectors rely on track and position data.

For some implementations, the method further includes receiving ADS-B integrity, and the GNSS integrity, track and position data for a plurality of aircraft located within the impacted area over multiple different times to determine a spoofing frequency within the impacted area.

One method of cloud processing for automatic dependent surveillance-broadcast (ADS-B) data to alert aircraft personnel to GNSS spoofing of aircraft guidance systems includes including receiving ADS-B receiver data including a history of ADS-B receiver activity and detecting a correlation between the GNSStrack and position data and the history of ADS-B receiver activity to associate a particular ADS-B receiver with a detected spoofing event. Another method includes tracking a pattern of identified anomalous flight path characteristics over time, detecting a pattern within the identified anomalous flight path characteristics over time, and using the detected pattern to score the identified anomalous flight path characteristics over time to quantify a certainty of spoofing. Other implementations of the method can further include providing an alert to the aircraft when the aircraft is approaching an area with detected spoofing or when the detected spoofing event has ceased based on a correction to the anomalous flight characteristic.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

One implementation includes a distributed network configured to process automatic dependent surveillance-broadcast (ADS-B) integrity, track and position data to detect spoofing events impacting a plurality of aircraft. The distributed network further includes a cloud-based alert system configured to analyze the ADS-B integrity, and the GNSS integrity, track and position data, received from one or more ADS-B data sources, for the plurality of aircraft in order to detect spoofing events and report detected spoofing events to Electronic Flight Bag (EFB) equipment or other system of software running on hardware onboard the plurality of aircraft, wherein analyzing the ADS-B integrity, and the GNSS integrity, track and position data further includes (i) comparing the ADS-B integrity, and the GNSS integrity, track and position data of a first aircraft to a plurality of operational limitations for the first aircraft or (ii) comparing the ADS-B integrity, and the GNSS integrity, track and position data of the first aircraft with the ADS-B integrity, and the GNSS integrity, track and position data of a second aircraft. The integrity data is optional, as many detectors rely on the track and position data. The distributed network also further includes an EFB tablet device or other system of software running on hardware, located on-board each aircraft within the plurality of aircraft, with a wireless connection to the cloud-based alert system, wherein the tablet device or the other system of software running on hardware receives spoofing reports from the cloud-based alert system.

In some implementations, a spoofing event is detected when an anomalous flight path characteristic is identified from the analyzed ADS-B integrity, and the analyzed GNSS integrity, track and position data, and wherein an anomalous flight path characteristic is one or more of a detected jump in position along a flight path segment that exceeds an airspeed limitation for the aircraft, a detected movement along the flight path segment that exceeds the airspeed limitation for the aircraft or a minimum turn radius limitation for the aircraft, a turn performed exceeding a range of 1.5-3 degrees per second, a change in speed greater than 10 knots/second, or a change in altitude greater than 6000 feet/minute.

In some implementations, the ADS-B data for the plurality of aircraft is transmitted by an ADS-B transponder onboard each aircraft, received by ADS-B receivers, and collected by a plurality of ADS-B open data sources including crowd-sourced ADS-B data services and air traffic control systems.

In one implementation, the cloud-based alert system is further configured to provide an alert of potential spoofing in a specific area to other aircraft via onboard EFB tablets, an air traffic base station, or other GNSS users. The distributed network can further include a deep learning model, trained using the stored ADS-B integrity, the stored GNSS integrity, track and position data and corresponding aircraft limitations, configured to process the ADS-B integrity, and the GNSS integrity, track and position data and generate, as output, a classification of the ADS-B integrity, and the GNSS integrity, track and position data as affected or unaffected by spoofing. The trained deep learning model can be further configured to generate, as output, a classification of a detected interference event within the ADS-B integrity, and the GNSS integrity, track and position data.

One implementation further includes the cloud-based alert system receiving the GNSStrack and position data from a plurality of aircraft located within the impacted area over multiple different times to determine a spoofing frequency within the impacted area. Another implementation further includes the cloud-based alert system receiving ADS-B receiver data including a history of ADS-B receiver activity and detecting a correlation between the

GNSStrack and position data and the history of ADS-B receiver activity to associate a particular ADS-B receiver with a detected spoofing event. Yet another implementation further includes the cloud-based alert system providing an alert to an aircraft when the aircraft is approaching an area with detected spoofing or when the detected spoofing event has ceased.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

Some implementations include a disclosed method of cloud processing for global navigation satellite system (GNSS) signal data from an external GNSS receiver onboard an aircraft, operating independently from certified avionics of the aircraft, to detect GNSS spoofing of aircraft guidance systems. The method can further include receiving, from an Electronic Flight Bag (EFB) tablet device linked to the external GNSS receiver at a cloud-based server, GNSS signal data from the external GNSS receiver, analyzing the GNSS signal data upon receipt, further including identifying an anomalous signal characteristic from the GNSS signal data, and in response to an identified anomalous signal characteristic, the cloud-based server providing an alert to the EFB tablet device onboard the aircraft causing notification of aircraft personnel of a potential spoofing event. An anomalous signal characteristic can be an anomalous signal strength of satellite signals compared to other received satellite signal strengths, an anomalous signal strength of satellite signals for an elevation and azimuth of source satellites, an anomalous elevation or azimuth of the satellite signals, an anomalous pseudo range of the satellite signals, an anomalous clock stability of the satellite signals, anomalous time codes of the satellite signals compared to other received satellite signals, incorrect, missing, or null values in the GNSS signal data, an anomalous change to broadcast almanac data, an anomalous change in AGC input levels, and/or a loss of usable GNSS signals followed by the anomalous signal characteristic.

In some implementations, the method further includes receiving, from the external GNSS receiver, GNSS track and position data, and analyzing the GNSS track and position data to identify an anomalous flight path characteristic indicative of a spoofing event, wherein the anomalous flight path characteristic is one or more of a detected jump in position along a flight path segment that exceeds an airspeed limitation for the aircraft, a detected movement along the flight path segment that exceeds the airspeed limitation for the aircraft or a minimum turn radius limitation for the aircraft, a turn performed exceeding a range of 1.5-3 degrees per second, a change in speed greater than 10 knots/second, or a change in altitude greater than 6000 feet/minute.

In some implementations, the method further includes receiving certified avionics GNSS data from the aircraft and comparing the certified avionics GNSS data to the external GNSS data to detect anomalous signal characteristics or anomalous flight path characteristics.

In some implementations, the method further includes providing an alert of potential spoofing in a specific area to other aircraft via onboard EFB tablets, an air traffic control base station, or other GNSS users via a cloud-based connection.

The method can include storing the GNSS signal data to a cloud storage.

In some implementations, the method includes training a deep learning model, using the stored GNSS signal data, to process GNSS signal data and generate, as output, a classification of the GNSS signal data as affected or unaffected by spoofing. The trained deep learning model can be further trained to generate, as output, a classification of a detected interference event within the GNSS signal data.

The method can further include receiving GNSS signal data from multiple GNSS receivers including external GNSS receivers and onboard certified avionics GNSS receivers, analyzing the GNSS signal data from the multiple GNSS receivers, and comparing the analyzed GNSS signal data across the multiple GNSS receivers to determine an area impacted by a detected spoofing threat, a size of the impacted area, and an expected impact on different types of GNSS systems.

Other implementations include receiving GNSS signal data from a plurality of GNSS receivers located within the impacted area over multiple different times to determine a spoofing frequency within the impacted area. Another implementation includes receiving ADS-B receiver data including a history of ADS-B receiver activity and detecting a correlation between the GNSS signal data and the history of ADS-B receiver activity to associate a particular ADS-B receiver with a detected spoofing event. One implementation includes tracking identified anomalous signal characteristics over time, detecting a pattern within the identified anomalous signal characteristics over time, and using the detected pattern to score the identified anomalous signal characteristics over time to quantify a certainty of spoofing.

Various implementations of the technology disclosed include processing the GNSS signal data using an API running on the EFB device and further processing the GNSS signal data using the cloud-based server.

One implementation of a disclosed distributed network is configured to analyze GNSS signal data from an external GNSS receiver onboard an aircraft, operating independently from certified avionics of the aircraft, to detect spoofing events impacting a plurality of aircraft. The distributed network also includes a cloud-based alert system configured to analyze the GNSS signal data from the external GNSS receiver, received from an Electronic Flight Bag (EFB) tablet device linked to the external GNSS receiver, in order to detect spoofing events and report detected spoofing events to the EFB tablet device onboard the plurality of aircraft, wherein analyzing the GNSS signal data further includes (i) identifying an anomalous signal characteristic within the GNSS signal data of a first GNSS receiver or (ii) comparing the GNSS signal data of the first GNSS receiver with the GNSS signal data of a second GNSS receiver and the EFB tablet device, located on-board each aircraft within the plurality of aircraft, with a wireless connection to the cloud-based alert system, wherein the tablet device (i) receives spoofing reports from the cloud-based alert system and (ii) reports GNSS signal data, from the external GNSS, to the cloud-based alert system. The method also includes detecting a spoofing event in response to an identified anomalous signal characteristic, wherein the identified anomalous signal characteristic is one or more of an anomalous signal strength of satellite signals compared to other received satellite signal strengths, an anomalous signal strength of satellite signals for an elevation and azimuth of source satellites, an anomalous elevation or azimuth of the satellite signals, an anomalous pseudo range of the satellite signals, an anomalous clock stability of the satellite signals, anomalous time codes of the satellite signals compared to other received satellite signals, incorrect, missing, or null values in the GNSS signal data, or a loss of usable GNSS signals followed by the anomalous signal characteristic.

The method also includes detecting a spoofing event in response to an identified anomalous flight path characteristic indicative of a spoofing event, wherein the anomalous flight path characteristic is one or more of a detected jump in position along a flight path segment that exceeds an airspeed limitation for the aircraft, a detected movement along the flight path segment that exceeds the airspeed limitation for the aircraft or a minimum turn radius limitation for the aircraft, a turn performed exceeding a range of 1.5-3 degrees per second, a change in speed greater than 10 knots/second, or a change in altitude greater than 6000 feet/minute.

In one implementation, the cloud-based alert system is further configured to provide an alert of potential spoofing in a specific area to other aircraft via onboard EFB tablets, an air traffic control base station, or other GNSS users via a cloud-based connection. In one implementation, the cloud-based alert system is further configured to store the GNSS signal data to a cloud storage.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

In some implementations, the distributed network further includes a deep learning model, trained using the stored GNSS signal data, configured to process GNSS signal data and generate, as output, a classification of the GNSS signal data as affected or unaffected by spoofing. The trained deep learning model can be further configured to generate, as output, a classification of a detected interference event within the GNSS signal data.

In some implementations, the cloud-based alert system is further configured to receive GNSS signal data from multiple GNSS receivers including external GNSS receivers, and onboard certified avionics GNSS receivers, analyze the GNSS signal data from the multiple GNSS receivers, and compare the analyzed GNSS signal data across the multiple GNSS receivers to determine an area impacted by a detected spoofing threat, a size of the impacted area, and an expected impact on different types of GNSS systems.

In some implementations, the cloud-based alert system is further configured to receive GNSS signal data from a plurality of GNSS receivers located within the impacted area over multiple different times to determine a spoofing frequency within the impacted area.

In some implementations, the cloud-based alert system is further configured to receive ADS-B receiver data including a history of ADS-B receiver activity and detect a correlation between the GNSS signal data and the history of ADS-B receiver activity to associate a particular ADS-B receiver with a detected spoofing event.

In some implementations, the cloud-based alert system is further configured to track identified anomalous signal characteristics over time, detect a pattern within the identified anomalous signal characteristics over time, and use the detected pattern to score the identified anomalous signal characteristics over time to quantify a certainty of spoofing. In other implementations, the GNSS signal data is processed using an API running on the EFB device and further processed by the cloud-based alert system.

One implementation is disclosed including a method of cloud processing for global navigation satellite system (GNSS) interference data from a plurality of GNSS receivers to alert aircraft personnel to GNSS spoofing of aircraft guidance systems, the method including receiving at a cloud-based server, GNSS interference data from the plurality of GNSS receivers associated with one or more of a certified avionics GNSS receiver onboard an aircraft, an external GNSS receiver linked to an Electronic Flight Bag (EFB) tablet device and independent of onboard certified avionics, cellular network base stations, automatic dependent surveillance-broadcast (ADS-B) networks, or dedicated GNSS monitoring facilities. Data from two or three or more of these data sources can be used. The method also includes analyzing the GNSS interference data upon receipt, including one or more of comparing a set of GNSS data for a particular aircraft to a plurality of operational limitations for the aircraft, comparing a first set of GNSS data to a second set of GNSS data, wherein the first and second sets of GNSS data are received from different GNSS receivers, onboard the same particular aircraft and operating independently of one another, or comparing a set of GNSS data for a first aircraft to a set of GNSS data for a second aircraft. The method also includes identifying an interference event from the analyzed GNSS interference data, wherein the interference event is an anomalous flight path characteristic of an aircraft or an anomalous signal characteristic of a GNSS signal, and in response to an identified interference event, the cloud-based server providing an alert to EFB tablet devices or other software running on hardware onboard the aircraft causing notification of aircraft personnel of a potential spoofing event.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

In some implementations, the GNSS interference data further includes one or more of GNSS track and position data, GNSS signal data, GNSS signal timing data, Receiver

Independent Exchange Format (RINEX) data, GNSS data by satellite data, uncompressed radiofrequency recordings, or GNSS dilution of precision (DOP) value data.

In some implementations, the method further includes further including analyzing the GNSS track and position data to identify an anomalous flight path characteristic indicative of a interference event, wherein the anomalous flight path characteristic is one or more of a detected jump in position along a flight path segment that exceeds an airspeed limitation for an aircraft, a detected movement along the flight path segment that exceeds the airspeed limitation for the aircraft or a minimum turn radius limitation for the aircraft, a turn performed exceeding a range of 1.5-3 degrees per second, a change in speed greater than 10 knots/second, or a change in altitude greater than 6000 feet/minute.

In some implementations, the method further includes analyzing the GNSS signal data upon receipt, further including identifying an anomalous signal characteristic from the GNSS signal data, and in response to an identified anomalous signal characteristic, the cloud-based server providing an alert to the EFB tablet device or other software running on hardware onboard the aircraft causing notification of aircraft personnel of a potential spoofing event. An anomalous signal characteristic can be an anomalous signal strength of satellite signals compared to other received satellite signal strengths, an anomalous signal strength of satellite signals for an elevation and azimuth of source satellites, an anomalous elevation or azimuth of the satellite signals, an anomalous pseudo range of the satellite signals, an anomalous clock stability of the satellite signals, anomalous time codes of the satellite signals compared to other received satellite signals, incorrect, missing, or null values in the GNSS signal data, an anomalous change to broadcast almanac data, an anomalous change in AGC input levels, and/or a loss of usable GNSS signals followed by the anomalous signal characteristic.

In some implementations, the method further includes further including providing an alert of the potential spoofing event in a specific area to other aircraft via onboard EFB tablets, an air traffic control base station, mobile network operators, airports, vehicle networks including V2X networks, or other GNSS users via a cloud-based connection. In other implementations, the method further includes storing the GNSS interference data to a cloud storage.

In some implementations, the method further includes training a deep learning model, using the stored GNSS interference data, to process GNSS interference data and generate, as output, a classification of the GNSS interference data as affected or unaffected by interference.

The deep learning model can be further trained to generate, as output, a classification of a detected interference event within the GNSS interference data.

One implementation includes a distributed network configured to analyze global navigation satellite system (GNSS) interference data from a plurality of GNSS receiver sources to detect spoofing events impacting a plurality of aircraft, the distributed network including a cloud-based alert system configured to analyze the GNSS interference data received from the plurality of sources in order to detect spoofing events and report detected spoofing events to EFB tablet devices onboard the plurality of aircraft, wherein analyzing the GNSS interference data further includes one or more of comparing a set of GNSS data for a particular aircraft to a plurality of operational limitations for the aircraft, comparing a first set of GNSS data to a second set of GNSS data, wherein the first and second sets of GNSS data are received from different GNSS receivers, onboard the same particular aircraft and operating independently of one another, or comparing a set of GNSS data for a first aircraft to a set of GNSS data for a second aircraft. In some implementations, the GNSS interference data is collected from networks such as 4G, 5G, and other communications networks included but not limited to terrestrial cellular communications or LEO satellite-based communication systems. The distributed network further includes an Electronic Flight Bag (EFB) tablet device, located on-board each aircraft within the plurality of aircraft, with a wireless connection to the cloud-based alert system, wherein the EFB tablet device (i) receives spoofing reports from the cloud-based alert system and (ii) reports GNSS interference data to the cloud-based alert system.

An alternative implementation takes into account residual impacts of spoofing after exiting a spoofed area. This method uses cloud processing of at least automatic dependent surveillance-broadcast (ADS-B) data to alert aircraft personnel to residual impacts to aircraft GPS systems after exiting an area of GNSS spoofing. The method includes receiving at a cloud-based server, from one or more ADS-B data sources, GNSS track and position data for an aircraft. Then, analyzing the one or more of and the GNSStrack and position data upon receipt. This involves comparing the one or more the GNSS track and position data to a plurality of operational limitations for the aircraft. From the comparison, an anomalous flight path characteristic can be determined using the GNSS track and position data.

The anomalous flight path characteristic can be one or more of: a detected low GPS integrity reported by the aircraft after exiting an area of known spoofing; a detected jump in position along a flight path segment that exceeds an airspeed limitation for the aircraft; a detected movement along the flight path segment that exceeds the airspeed limitation for the aircraft or a minimum turn radius limitation for the aircraft; a turn performed exceeding a range of 1.5-3 degrees per second; or a change in speed greater than 10 knots/second.

In response to an identified anomalous flight path characteristic, the cloud-based server provides an alert to an Electronic Flight Bag (EFB) tablet device onboard the aircraft or to airline operations and dispatch software. The alert notifies aircraft personnel of residual impacts to aircraft GPS systems.

Another implementation of this technology involves detecting a jump in position along a flight path segment that exceeds an airspeed limitation for the aircraft. This method includes receiving a change in latitude and longitude from an aircraft, typically successive GNSS reports. When the change in position over any time period deviates from a reported airspeed from the aircraft's pitot static system by more than 150 percent or less than 66 percent, the GNSS report is identified as an anomalous flight path characteristic. The pitot static system or a similar system measures air pressure and speed of resulting from flight, without dependence on GNSS. A system responds to a difference between pressure and GNSS calculations of speed by raising a spoofing alert.

The change in position can be smoothed over multiple intervals of latitude and longitude reports when calculating the change in latitude and longitude from the aircraft. For instance, three, four or five readings or in a range of four to 25 readings could be used. A rapid change in smoothed groundspeed can be calculated as:

total_distance / (average_time_delta * X), average_time_delta − average from X time
differences, X is dynamic <=5.
Smoothed_speed_diff: abs(smoothed_speed0−smoothed_speed1)

Further implementations of the technology disclosed address residual effects of spoofing and detection of spoofing using ram airspeed and using barometric altitude, neither of which are based on GNSS readings. Related to residual impacts are methods implemented using a cloud-based server and/or an Electronic Fight Bag (EFB) tablet. The cloud-based processing utilizes automatic dependent surveillance-broadcast (ADS-B) data and alerting aircraft personnel to residual impacts of spoofing on GNSS systems of a first aircraft while transiting a second area after exiting a first area of GNSS spoofing. The cloud-based server identifies the first aircraft as having entered and exited a first area of GNSS spoofing during a flight. This can include the first aircraft reported conditions recognized as a first spoofing start and first spoofing stop. Later in the same flight, after the first aircraft has exited the first area, the cloud-based server receives, from one or more ADS-B data sources, data reflecting GNSStrack, and position data for the first aircraft. The server analyzes the GNSS track and/or position data upon receipt, including comparing the GNSS track and/or position data to a plurality of operational limitations for the first aircraft. The operational limitations of the aircraft can be stored based on the individual aircraft or the aircraft model. The server identifies a data integrity issue or an anomalous flight path issue, collectively referred to as the issue. It analyzes reports for other aircraft transiting the second area and determines that the other aircraft are not in experience spoofing in the second area. In response to the issue experienced by the first aircraft but not by the other aircraft in the second area, the cloud-based server alerts an Electronic Flight Bag (EFB) tablet device onboard the first aircraft or alerts airline operations and dispatch software, thereby causing notification of first aircraft personnel of the residual impacts to first aircraft GNSS systems.

This implementation can further include, identifying one or more of the following issues from the analysis of ADS-B integrity, and/or the GNSS integrity, track and position data: a detected low ADS-B or GNSS integrity reported by the first aircraft after exiting an area of known spoofing, a detected jump in position along a flight path segment that exceeds an airspeed limitation for the first aircraft, a detected movement along the flight path segment that exceeds the airspeed limitation for the first aircraft or a minimum turn radius limitation for the first aircraft, a turn performed exceeding a range of 1.5-3 degrees per second, or a change in speed greater than 10 knots/second. In some instances, the issue is the data integrity issue. In other instances, the issue is the anomalous flight path issue.

Responsive to the determination of residual impacts to the first aircraft GNSS systems, the server can further exclude data from the first aircraft from mapping of spoofed areas after the first aircraft has exited the first spoofed area. This reduces likelihood that residual errors from the first aircraft GNSS will lead to false designation of an area as spoofed.

Additional implementations of the technology disclosed use combine GNSS data and non-GNSS data. The non-GNSS data can include ram airspeed and barometric altitude data. The ram airspeed method determines spoofing of a GNSS, by receiving at a cloud-based server a series of reports of GNSS latitude and longitude from an aircraft's GNSS and reports of airspeed from the aircraft's pitot static system. The cloud-based server determines a corresponding groundspeed of the aircraft that deviates from the airspeed from such that the groundspeed is more than 150 percent or less than 66 percent of the airspeed. In response to the deviation between the groundspeed and the airspeed, the cloud-based server provides an alert to an Electronic Flight Bag (EFB) tablet device onboard the aircraft. The EFB notifies aircraft personnel of a potential spoofing event or causes them to be notified.

The groundspeed determination can include the cloud-based server or another system component smoothing the change in latitude and longitude over multiple reports from the aircraft of latitude and longitude aircraft.

An alternative implementation of ram airspeed method determines spoofing of a GNSS, by receiving at an Electronic Flight Bag (EFB) tablet device onboard an aircraft a series of reports of GNSS latitude and longitude from the aircraft's GNSS and determining a corresponding groundspeed of the aircraft. The EFB tablet device also receives a reported airspeed from the aircraft's pitot static system. The EFB tablet device determine that the groundspeed is more than 150 percent or less than 66 percent of the airspeed. In response to the deviation between the groundspeed and the airspeed. The EFB notifies aircraft personnel of a potential spoofing event or causes them to be notified. Optionally, the EFB can further send a first report of the potential spoofing event to a cloud-based server.

The groundspeed determination can include the EFB or another system component smoothing the change in latitude and longitude over multiple reports from the aircraft of latitude and longitude aircraft.

Two implementations using barometric altitude can be implemented using either a server or an EFB tablet device. Both provide a method to determine spoofing of a GNSS. One includes receiving at a cloud-based server a series of reports of GNSS latitude and longitude from an aircraft's GNSS and reports of barometric altitude the aircraft's barometric instruments. The cloud-based server analyzes the barometric altitude and the groundspeed based on the series of the GNSS latitude and longitude reports. It determines spoofing from one or more of: the groundspeed is implausibly slow for flight, being 50 knots or less other than during takeoff or landing; the groundspeed is excessive at a low altitude, being over 350 knots at a barometric altitude of less than 18,000 feet; or the groundspeed is too slow for the altitude, based on a ratio of the barometric altitude in feet divided by the groundspeed in knots that exceeds 500. In response to the analysis of the barometric altitude and the groundspeed, the cloud-based server providing an alert to an Electronic Flight Bag (EFB) tablet device onboard the aircraft. The EFB notifies or causes notification to aircraft personnel of a potential spoofing event.

The other implementation using barometric altitude relies on an EFB tablet device. The EFB receives and analyzes the series of reports of GNSS latitude and longitude from an aircraft's GNSS and reports of barometric altitude the aircraft's barometric instruments, as would the server. It determines spoofing and notifies or causes notification to aircraft personnel of a potential spoofing event. Optionally, the EFB can further send a first report of the potential spoofing event to a cloud-based server.

Regardless of the hardware that carries out the method, for the groundspeed being over 350 knots at a barometric altitude of less than 18,000 feet, the method can further include determining a ratio of the groundspeed to the barometric altitude.

The technology disclosed can be practiced as a system, method, or article of manufacture. One or more features of any implementation can be combined with any of the base implementations. Implementations that are not mutually exclusive are taught to be combinable. One or more features of an implementation can be combined with other implementations. This disclosure periodically reminds the user of these options.

While the technology disclosed is disclosed by reference to the preferred

embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

### CLAUSES

1. A method of cloud processing for global navigation satellite system (GNSS) signal data from an external GNSS receiver onboard an aircraft, operating independently from certified avionics of the aircraft, to detect GNSS spoofing of aircraft guidance systems, the method including:
receiving, from an Electronic Flight Bag (EFB) tablet device or from other software running on hardware, linked to the external GNSS receiver at a cloud-based server, GNSS signal data from the external GNSS receiver;
analyzing the GNSS signal data upon receipt, further including identifying an anomalous signal characteristic from the GNSS signal data, wherein the anomalous signal characteristic is:
   an anomalous signal strength of satellite signals compared to other received satellite signal strengths,
   an anomalous signal strength of satellite signals for an elevation and azimuth of source satellites,
   an anomalous elevation or azimuth of the satellite signals,
   an anomalous pseudo range of the satellite signals,
   an anomalous clock stability of the satellite signals,
   anomalous time codes of the satellite signals compared to other received satellite signals,
   incorrect, missing, or null values in the GNSS signal data,
   an anomalous change to broadcast almanac data,
   an anomalous change in AGC input levels, or
   a loss of usable GNSS signals followed by the anomalous signal characteristic; and
in response to an identified anomalous signal characteristic, the cloud-based server providing an alert to the EFB tablet device or other software running on hardware onboard the aircraft thereby causing notification of aircraft personnel of a potential spoofing event.

2. The method of clause 1, further including receiving, from the external GNSS receiver, GNSS track and position data, and analyzing the GNSS track and position data to identify an anomalous flight path characteristic indicative of a spoofing event, wherein the anomalous flight path characteristic is one or more of:
a detected jump in position along a flight path segment that exceeds an airspeed limitation for the aircraft,
a detected movement along the flight path segment that exceeds the airspeed limitation for the aircraft or a minimum turn radius limitation for the aircraft,
a turn performed exceeding a range of 1.5-3 degrees per second,
a change in speed greater than 10 knots/second, or
a change in altitude greater than 6000 feet/minute.

3. The method of clause 1, further including receiving certified avionics GNSS data from the aircraft and comparing the certified avionics GNSS data to the external GNSS data to detect anomalous signal characteristics or anomalous flight path characteristics.

4. The method of clause 1, further including providing an alert of potential spoofing in a specific area to other aircraft via onboard EFB tablets, an air traffic control base station, or other GNSS users via a cloud-based connection.

5. The method of clause 1, further including storing the GNSS signal data to a cloud storage.

6. The method of clause 5, further including training a deep learning model, using the stored GNSS signal data, to process GNSS signal data and generate, as output, a classification of the GNSS signal data as affected or unaffected by spoofing.

7. The method of clause 6, wherein the trained deep learning model is further trained to generate, as output, a classification of a detected interference event within the GNSS signal data.

8. The method of clause 1, further including:
receiving GNSS signal data from multiple GNSS receivers including external GNSS receivers and onboard certified avionics GNSS receivers;
analyzing the GNSS signal data from the multiple GNSS receivers; and
comparing the analyzed GNSS signal data across the multiple GNSS receivers to determine an area impacted by a detected spoofing threat, a size of the impacted area, and an expected impact on different types of GNSS systems.

9. The method of clause 8, further including receiving GNSS signal data from a plurality of GNSS receivers located within the impacted area over multiple different times to determine a spoofing frequency within the impacted area.

10. The method of clause 1, further including receiving ADS-B receiver data including a history of ADS-B receiver activity and detecting a correlation between the GNSS signal data and the history of ADS-B receiver activity to associate a particular ADS-B receiver with a detected spoofing event.

11. The method of clause 1, further including tracking identified anomalous signal characteristics over time, detecting a pattern within the identified anomalous signal characteristics over time, and using the detected pattern to score the identified anomalous signal characteristics over time to quantify a certainty of spoofing.

12. The method of clause 1, further including processing the GNSS signal data using an app running on the EFB device and further processing the GNSS signal data using the cloud-based server.

13. A distributed network configured to analyze global navigation satellite system (GNSS) signal data from an external GNSS receiver onboard an aircraft, operating independently from certified avionics of the aircraft, to detect GNSS spoofing of aircraft guidance systems, the distributed network including:
a cloud-based server configured to receive, from an Electronic Flight Bag (EFB) tablet device or from other software running on hardware, linked to the external GNSS receiver at a cloud-based server, GNSS signal data from the external GNSS receiver;
the cloud-based server further configured to analyze the GNSS signal data upon receipt, further including identifying an anomalous signal characteristic from the GNSS signal data, wherein the anomalous signal characteristic is:
   an anomalous signal strength of satellite signals compared to other received satellite signal strengths,
   an anomalous signal strength of satellite signals for an elevation and azimuth of source satellites,
   an anomalous elevation or azimuth of the satellite signals,
   an anomalous pseudo range of the satellite signals,
   an anomalous clock stability of the satellite signals,
   anomalous time codes of the satellite signals compared to other received satellite signals,
   incorrect, missing, or null values in the GNSS signal data,
   an anomalous change to broadcast almanac data,
   an anomalous change in AGC input levels, or
   a loss of usable GNSS signals followed by the anomalous signal characteristic; and
the cloud-based server further configured, in response to an identified anomalous signal characteristic, to provide an alert to the EFB tablet device or the other software running on hardware onboard the aircraft thereby causing notification of aircraft personnel of a potential spoofing event.

14. A distributed network configured to analyze GNSS signal data from an external GNSS receiver onboard an aircraft, operating independently from certified avionics of the aircraft, and detecting spoofing events impacting a plurality of aircraft, the method including:
a cloud-based server configured to analyze the GNSS signal data from the external GNSS receiver, received from an Electronic Flight Bag (EFB) tablet device or from other software running on hardware, linked to the external GNSS receiver, detecting spoofing events and reporting detected spoofing events to the EFB tablet device or the other software running on hardware onboard the plurality of aircraft,
wherein analyzing the GNSS signal data further includes:
   identifying an anomalous signal characteristic within the GNSS signal data of a first GNSS receiver or
   comparing the GNSS signal data of the first GNSS receiver with the GNSS signal data of a second GNSS receiver; and
the EFB tablet device or the other software running on hardware connection to the cloud-based alert system:
   receiving spoofing reports from the cloud-based alert system and
   reporting GNSS signal data, from the external GNSS, to the cloud-based alert system.

15. The distributed network of clause 14, wherein a spoofing event is detected in response to an identified anomalous signal characteristic, and wherein the identified anomalous signal characteristic is one or more of:
an anomalous signal strength of satellite signals compared to other received satellite signal strengths,
an anomalous signal strength of satellite signals for an elevation and azimuth of source satellites,
an anomalous elevation or azimuth of the satellite signals,
an anomalous pseudo range of the satellite signals,
an anomalous clock stability of the satellite signals,
anomalous time codes of the satellite signals compared to other received satellite signals,
incorrect, missing, or null values in the GNSS signal data, or
a loss of usable GNSS signals followed by the anomalous signal characteristic.

16. The distributed network of clause 15, wherein the cloud-based alert system is further configured to receive, from the EFB tablet device linked to the external GNSS receiver, GNSS track and position data, and analyze the GNSS track and position data to identify an anomalous flight path characteristic indicative of a spoofing event, wherein the anomalous flight path characteristic is one or more of:
a detected jump in position along a flight path segment that exceeds an airspeed limitation for the aircraft,
a detected movement along the flight path segment that exceeds the airspeed limitation for the aircraft or a minimum turn radius limitation for the aircraft,
a turn performed exceeding a range of 1.5-3 degrees per second,
a change in speed greater than 10 knots/second, or
a change in altitude greater than 6000 feet/minute.

17. The distributed network of clause 14, wherein the cloud-based alert system is further configured to provide an alert of potential spoofing in a specific area to other aircraft via onboard EFB tablets, an air traffic control base station, or other GNSS users via a cloud-based connection.

18. The distributed network of clause 14, wherein the cloud-based alert system is further configured to store the GNSS signal data to a cloud storage.

19. The distributed network of clause 18, further including a deep learning model, trained using the stored GNSS signal data, configured to process GNSS signal data and generate, as output, a classification of the GNSS signal data as affected or unaffected by spoofing.

20. The distributed network of clause 19, wherein the trained deep learning model is further configured to generate, as output, a classification of a detected interference event within the GNSS signal data.

21. The distributed network of clause 14, wherein the cloud-based alert system is further configured to:
receive GNSS signal data from multiple GNSS receivers including external GNSS receivers, and onboard certified avionics GNSS receivers;
analyze the GNSS signal data from the multiple GNSS receivers; and
compare the analyzed GNSS signal data across the multiple GNSS receivers to determine an area impacted by a detected spoofing threat, a size of the impacted area, and an expected impact on different types of GNSS systems.

22. The distributed network of clause 21, wherein the cloud-based alert system is further configured to receive GNSS signal data from a plurality of GNSS receivers located within the impacted area over multiple different times to determine a spoofing frequency within the impacted area.

23. The distributed network of clause 14, wherein the cloud-based alert system is further configured to receive ADS-B receiver data including a history of ADS-B receiver activity and detect a correlation between the GNSS signal data and the history of ADS-B receiver activity to associate a particular ADS-B receiver with a detected spoofing event.

24. The distributed network of clause 14, wherein the cloud-based alert system is further configured to track identified anomalous signal characteristics over time, detect a pattern within the identified anomalous signal characteristics over time, and use the detected pattern to score the identified anomalous signal characteristics over time to quantify a certainty of spoofing.

25. The distributed network of clause 14, wherein the GNSS signal data is processed using an app running on the EFB device and further processed by the cloud-based alert system.

26. A method of analyzing GNSS signal data from an external GNSS receiver onboard an aircraft, operating independently from certified avionics of the aircraft, and detecting spoofing events impacting a plurality of aircraft, the method including:
a cloud-based alert system analyzing the GNSS signal data from the external GNSS receiver, received from an Electronic Flight Bag (EFB) tablet device or from other software running on hardware, linked to the external GNSS receiver, detecting spoofing events and reporting detected spoofing events to the EFB tablet device or the other software running on hardware onboard the plurality of aircraft,
wherein analyzing the GNSS signal data further includes
   identifying an anomalous signal characteristic within the GNSS signal data of a first GNSS receiver or
   comparing the GNSS signal data of the first GNSS receiver with the GNSS signal data of a second GNSS receiver; and
the EFB tablet device or the other software running on hardware connection to the cloud-based alert system:
   receiving spoofing reports from the cloud-based alert system and
   reporting GNSS signal data, from the external GNSS, to the cloud-based alert system.

We claim as follows:

1. A method of cloud processing automatic dependent surveillance-broadcast (ADS-B) data and alerting aircraft personnel to residual impacts of spoofing on GNSS systems of a first aircraft while transiting a second area after exiting a first area of GNSS spoofing, the method including:
a cloud-based server identifying the first aircraft as having entered and exited a first area of GNSS spoofing during a flight, accompanied by having registered conditions recognized as a first spoofing start and first spoofing stop;
later in the flight, after the first aircraft has exited the first area, receiving at the cloud-based server, from one or more ADS-B data sources, data reflecting ADS-B integrity, and the GNSS integrity, track, and position data for the first aircraft;
analyzing the ADS-B integrity, and the GNSS integrity, track and position data upon receipt, including comparing the GNSS track and position data to a plurality of operational limitations for the first aircraft;
identifying a data integrity issue or an anomalous flight path issue, collectively the issue,
analyzing reports for other aircraft transiting the second area and determining that the other aircraft are not in experience spoofing in the second area;
in response to the issue experienced by the first aircraft but not by the other aircraft in the second area, the cloud-based server providing an alert to an Electronic Flight Bag (EFB) tablet device onboard the first aircraft or airline operations and dispatch software running on hardware thereby causing notification of first aircraft personnel of the residual impacts to a first aircraft GNSS system.

2. The method of claim 1, further including:
identifying the issue from the analyzed ADS-B integrity, and the GNSS integrity, track and position data, wherein the issue is one or more of:
a detected low ADS-B or GNSS integrity reported by the first aircraft after exiting an area of known spoofing,
a detected jump in position along a flight path segment that exceeds an airspeed limitation for the first aircraft,
a detected movement along the flight path segment that exceeds the airspeed limitation for the first aircraft or a minimum turn radius limitation for the first aircraft,
a turn performed exceeding a range of 1.5-3 degrees per second, or
a change in speed greater than 10 knots/second.

3. The method of claim 1, wherein the issue is the data integrity issue.

4. The method of claim 1, wherein the issue is the anomalous flight path issue.

5. The method of claim 1, further including the cloud-based server using the determination of residual impacts to the first aircraft GNSS systems to exclude data from the first aircraft from mapping of spoofed areas after the first aircraft has exited the first spoofed area.

6. A cloud-based alert system configured to process automatic dependent surveillance-broadcast (ADS-B) data and alert aircraft personnel to residual impacts of spoofing on GNSS systems of a first aircraft while transiting a second area after exiting a first area of GNSS spoofing, including:
a cloud-based server configured to identify the first aircraft as having entered and exited a first area of GNSS spoofing during a flight, accompanied by having registered conditions recognized as a first spoofing start and first spoofing stop;
further configured to, later in the flight, after the first aircraft has exited the first area, receive at the cloud-based server, from one or more ADS-B data sources, data reflecting ADS-B integrity, and the GNSS integrity, track, and position data for the first aircraft;
further configured to analyze the ADS-B integrity, and the GNSS integrity, track and position data upon receipt, including comparing the GNSS track and position data to a plurality of operational limitations for the first aircraft;
further configured to identify a data integrity issue or an anomalous flight path issue, collectively the issue,
further configured to analyze reports for other aircraft transiting the second area and determining that the other aircraft are not in experience spoofing in the second area;
further configured to, in response to the issue experienced by the first aircraft but not by the other aircraft in the second area, provide an alert to an Electronic Flight Bag (EFB) tablet device onboard the first aircraft or airline operations and dispatch software running on hardware thereby causing notification of first aircraft personnel of the residual impacts to a first aircraft GNSS system.

7. The cloud-based alert system of claim 6, further configured to:
identify the issue from the analyzed ADS-B integrity, and the GNSS integrity, track and position data, wherein the issue is one or more of:
a detected low ADS-B or GNSS integrity reported by the first aircraft after exiting an area of known spoofing,
a detected jump in position along a flight path segment that exceeds an airspeed limitation for the first aircraft,
a detected movement along the flight path segment that exceeds the airspeed limitation for the first aircraft or a minimum turn radius limitation for the first aircraft,
a turn performed exceeding a range of 1.5-3 degrees per second, or
a change in speed greater than 10 knots/second.

8. The cloud-based alert system of claim 6, wherein the issue is the data integrity issue.

9. The cloud-based alert system of claim 6, wherein the issue is the anomalous flight path issue.

10. The cloud-based alert system of claim 6, further configured to use the determination of residual impacts to the first aircraft GNSS systems to exclude data from the first aircraft from mapping of spoofed areas after the first aircraft has exited the first spoofed area.

11. A method to determine spoofing of a GNSS, including:
receiving at a cloud-based server a series of reports of GNSS latitude and longitude from an aircraft's GNSS and reports of airspeed from the aircraft's pitot static system;
the cloud-based server determining a corresponding groundspeed of the aircraft that deviates from the airspeed from such that the groundspeed is more than 150 percent or less than 66 percent of the airspeed; and
in response to the deviation between the groundspeed and the airspeed, the cloud-based server providing an alert to an Electronic Flight Bag (EFB) tablet device onboard the aircraft or airline operations and dispatch software running on hardware thereby causing notification of aircraft personnel of a potential spoofing event.

12. The method of claim 11, further including smoothing the change in latitude and longitude over multiple reports from the aircraft of latitude and longitude aircraft.

13. The method of claim 11, further including the cloud-based server smoothing the change in latitude and longitude over multiple reports from the aircraft of latitude and longitude aircraft.

14. A method to determine and report spoofing of a GNSS, including:
receiving at an Electronic Flight Bag (EFB) tablet device or other software running on hardware onboard an aircraft a series of reports of GNSS latitude and longitude from the aircraft's GNSS and determining a corresponding groundspeed of the aircraft;
receiving at the EFB tablet device a reported airspeed from the aircraft's pitot static system;
the EFB tablet device or the other software running on hardware determining that the groundspeed is more than 150 percent or less than 66 percent of the airspeed; and
in response to the deviation between the groundspeed and the airspeed, the EFB tablet device or the other software running on hardware onboard the aircraft thereby causing notification of aircraft personnel of a potential spoofing event and sending a first report of the potential spoofing event to a cloud-based server.

15. The method of claim 14, further including smoothing the change in latitude and longitude over multiple reports from the aircraft's GNSS of the latitude and longitude.

16. The method of claim 14, further including the EFB tablet device receiving, in response to the first report, a second report from the cloud-based server that the aircraft has entered an area of reported GNSS spoofing.

17. A method to determine spoofing of a GNSS, including:
receiving at a cloud-based server a series of reports of GNSS latitude and longitude from an aircraft's GNSS and reports of barometric altitude from the aircraft's barometric instruments;
the cloud-based server analyzing the barometric altitude and the groundspeed based on the series of the GNSS latitude and longitude reports and determining spoofing from one or more of:
the groundspeed is implausibly slow for flight, being 50 knots or less other than during takeoff or landing;
the groundspeed is excessive at a low altitude, being over 350 knots at a barometric altitude of less than 18,000 feet; or
the groundspeed is too slow for the altitude, based on a ratio of the barometric altitude in feet divided by the groundspeed in knots that exceeds 500;
in response to the analysis of the barometric altitude and the groundspeed, the cloud-based server providing an alert to an Electronic Flight Bag (EFB) tablet device onboard the aircraft thereby causing notification of aircraft personnel of a potential spoofing event.

18. The method of claim 17, further including, for the groundspeed being over 350 knots at a barometric altitude of less than 18,000 feet, determining a ratio of the groundspeed to the barometric altitude.

19. A method to determine spoofing of a GNSS, including:
receiving at an Electronic Flight Bag (EFB) tablet device or other software running on hardware onboard an aircraft a series of reports of GNSS latitude and longitude from an aircraft's GNSS and reports of barometric altitude the aircraft's barometric instruments;
the EFB tablet device or the other software running on hardware analyzing the barometric altitude and the groundspeed based on the series of the GNSS latitude and longitude reports and determining spoofing from one or more of:
the groundspeed is implausibly slow for flight, being 50 knots or less other than during takeoff or landing;
the groundspeed is excessive at a low altitude, being over 350 knots at a barometric altitude of less than 18,000 feet; or
the groundspeed is too slow for the altitude, based on a ratio of the barometric altitude in feet divided by the groundspeed in knots that exceeds 500;
in response to the analysis of the barometric altitude and the groundspeed, the EFB tablet device or the other software running on hardware onboard the aircraft thereby causing notification of aircraft personnel of a potential spoofing event or causing the aircraft personnel to be notified.

20. The method of claim 19, further including, for the groundspeed being over 350 knots at a barometric altitude of less than 18,000 feet, determining a ratio of the groundspeed to the barometric altitude.

21. A cloud-based alert system configured to determine spoofing of a GNSS, including:
a cloud-based server configured to receive a series of reports of GNSS latitude and longitude from an aircraft's GNSS and reports of airspeed from the aircraft's pitot static system;
further configured to determine a corresponding groundspeed of the aircraft that deviates from the airspeed from such that the groundspeed is more than 150 percent or less than 66 percent of the airspeed; and
further configured, in response to the deviation between the groundspeed and the airspeed, to provide an alert to an Electronic Flight Bag (EFB) tablet device onboard the aircraft or airline operations and dispatch software running on hardware thereby causing notification of aircraft personnel of a potential spoofing event.

22. The cloud-based alert system of claim 21, further configured to smooth the change in latitude and longitude over multiple reports from the aircraft of latitude and longitude aircraft.

23. A cloud-based alert system configured to determine spoofing of a GNSS, including:
a cloud-based server configured to receive a series of reports of GNSS latitude and longitude from an aircraft's GNSS and reports of barometric altitude the aircraft's barometric instruments;
further configured to analyze the barometric altitude and the groundspeed based on the series of the GNSS latitude and longitude reports and determine spoofing from one or more of:
the groundspeed is implausibly slow for flight, being 50 knots or less other than during takeoff or landing;
the groundspeed is excessive at a low altitude, being over 350 knots at a barometric altitude of less than 18,000 feet; or
the groundspeed is too slow for the altitude, based on a ratio of the barometric altitude in feet divided by the groundspeed in knots that exceeds 500;
further configured, in response to the analysis of the barometric altitude and the groundspeed, to provide an alert to an Electronic Flight Bag (EFB) tablet device onboard the aircraft or airline operations and dispatch software running on hardware thereby causing notification of aircraft personnel of a potential spoofing event.

24. The cloud-based alert system of claim 23, further configured, for the groundspeed being over 350 knots at a barometric altitude of less than 18,000 feet, determine a ratio of the groundspeed to the barometric altitude.
